(19) United States
(12) Patent Application Publication
(10) Pub. No.: US 2026/0089071 A1
(43) Pub. Date: Mar. 26, 2026

(54) COMMUNICATION METHOD AND RELATED DEVICE

(71) Applicant: HUAWEI TECHNOLOGIES CO., LTD., Shenzhen (CN)

(72) Inventors: Yunfei Qiao, Hangzhou (CN); Gongzheng Zhang, Hangzhou (CN); Jian Wang, Hangzhou (CN)

(73) Assignee: HUAWEI TECHNOLOGIES CO., LTD., Shenzhen (CN)

(21) Appl. No.: 19/343,771

(22) Filed: Sep. 29, 2025

Related U.S. Application Data
(63) Continuation of application No. PCT/CN2023/085020, filed on Mar. 30, 2023.

(51) Int. Cl. H04L 41/16; H04W 72/23

(52) U.S. Cl. CPC H04L 41/16; H04W 72/23

(57) ABSTRACT

This application provides a communication method and a related device, so that in a manner in which a network device provides configuration information of an AI service, a terminal device can transmit service information of the AI service based on the configuration information of the AI service, to implement integration of AI computing power and a communication network. In the method, the terminal device receives the configuration information of the AI service from the network device, where the configuration information of the AI service indicates configuration information of a connection function and at least one of the following: an identifier of the AI service, configuration information of a computing function, configuration information of a sensing function, and configuration information of a data function. The terminal device receives or sends the service information of the AI service based on the configuration information of the AI service.

### CROSS-REFERENCE TO RELATED APPLICATIONS

This is a continuation of International Application No. PCT/CN2023/085020, filed on Mar. 30, 2023, the disclosure of which is hereby incorporated by reference in its entirety.

### TECHNICAL FIELD

This application relates to the communication field, and in particular, to a communication method and a related device.

### BACKGROUND

Wireless communication is transmission communication performed between two or more communication nodes without propagation using a conductor or a cable. The communication node usually includes a network device and a terminal device.

Currently, in a wireless communication system, a communication node usually has a signal receiving and sending capability and a computing capability. A network device having a computing capability is used as an example. The computing capability of the network device is mainly to provide computing power support for a signal receiving and sending capability (for example, perform computation on a time domain resource, a frequency domain resource, and the like that carry a signal), to implement communication between the network device and another communication node.

However, in a future communication network, in addition to communication between different communication nodes, artificial intelligence (artificial intelligence, AI) computing power may also need to be considered.

Therefore, how to integrate AI computing power with a communication network is an urgent technical problem to be resolved.

### SUMMARY

This application provides a communication method and a related device, in which a network device provides configuration information of an AI service, so that a terminal device can transmit service information of the AI service based on the configuration information of the AI service, to implement integration of AI computing power and a communication network.

A first aspect of this application provides a communication method. The method is performed by a terminal device. Alternatively, the method is performed by a part of components (for example, a processor, a chip, or a chip system) in a terminal device. Alternatively, the method may be implemented by a logical module or software that can implement all or a part of functions of a terminal device. In the first aspect and possible implementations of the first aspect, an example in which the method is performed by the terminal device is used for description. In the method, the terminal device receives configuration information of an AI service, where the configuration information of the AI service indicates configuration information of a connection function and at least one of the following: an identifier of the AI service, configuration information of a computing function, configuration information of a sensing function, and configuration information of a data function. The terminal device receives or sends service information of the AI service based on the configuration information of the AI service.

According to the foregoing technical solution, in addition to indicating the configuration information of the connection function, the configuration information of the AI service received by the terminal device further indicates at least one of the identifier of the AI service, the configuration information of the computing function, the configuration information of the sensing function, and the configuration information of the data function. Therefore, the terminal device receives or sends the service information of the AI service based on the configuration information of the connection function and the at least one piece of configuration information. In this way, a network device provides the configuration information of the AI service, so that the terminal device can transmit the service information of the AI service based on the configuration information of the AI service, to implement integration of AI computing power and a communication network.

It should be noted that the configuration information of the AI service may be used for one or more AI service instances (or referred to as one or more AI services, or referred to as one or more AI tasks, or the like). The AI service instance (or the AI service, the AI task, or the like) may include: a single network device providing an AI training service, a plurality of network devices providing an AI training service, AI split-learning, AI federated learning, or other implementations. This is not limited herein.

Optionally, the configuration information of the connection function indicated by the configuration information of the AI service includes at least one of configuration information of a service data adaptation layer (service data adaptation protocol, SDAP) layer, configuration information of a packet data convergence layer (packet data convergence protocol, PDCP) layer, configuration information of a radio link control (radio link control, RLC) layer, configuration information of a media access control (media access control, MAC) layer, and configuration information of a physical (physical, PHY) layer. Therefore, the terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

Optionally, the configuration information of the computing function indicated by the configuration information of the AI service is for AI model training and/or AI model inference. Therefore, the terminal device can participate in an AI computing process in the AI service scenario based on the configuration information of the AI service.

Optionally, the configuration information of the sensing function indicated by the configuration information of the AI service is for environment parameter measurement and/or environment parameter reporting. Therefore, the terminal device can implement an environment sensing process in the AI service scenario based on the configuration information of the AI service.

Optionally, the configuration information of the data function indicated by the configuration information of the AI service is used to collect data and/or augment data. Therefore, the terminal device can implement an AI data processing process in the AI service scenario based on the configuration information of the AI service.

In a possible implementation of the first aspect, a part or all of the service information of the AI service is carried on a physical downlink shared channel (physical downlink shared channel, PDSCH), and control information associated with the PDSCH indicates the AI service.

According to the foregoing technical solution, the service information of the AI service transmitted based on the configuration information of the AI service may be carried on the PDSCH, and the control information associated with the PDSCH indicates the AI service, so that the terminal device can identify, based on the control information, information carried on the PDSCH.

Optionally, the control information is downlink control information (downlink control information, DCI) or a media access control control element (media access control control element, MAC CE) transmitted on a physical downlink control channel (physical downlink control channel, PDCCH).

In a possible implementation of the first aspect, before the terminal device receives the configuration information of the AI service, the method further includes: The terminal device sends request information used to request the AI service.

According to the foregoing technical solution, the terminal device may send the request information used to request the AI service, so that the network device sends the configuration information of the AI service based on the request information. Therefore, the foregoing technical solution is applicable to a scenario in which the terminal device requests the AI service.

In a possible implementation of the first aspect, the request information includes at least one of the following: local data resource information of the terminal device, motion status information of the terminal device, local data service capability information of the terminal device, local computing service capability information of the terminal device, local sensing service capability information of the terminal device, local connection service capability information of the terminal device, service type description information of the AI service, and service target description information of the AI service.

According to the foregoing technical solution, the request information sent by the terminal device may include at least one of the foregoing items, so that the network device sends, based on the at least one item, the configuration information of the AI service corresponding to the request information.

In a possible implementation of the first aspect, that the terminal device receives or sends the service information of the AI service based on the configuration information of the AI service includes: The terminal device receives or sends data resource information of the AI service based on the configuration information of the AI service.

According to the foregoing technical solution, in a process in which the terminal device receives or sends the service information of the AI service based on the configuration information of the AI service, the terminal device may receive the data resource information of the AI service, so that the terminal device locally performs AI computing based on the data resource information of the AI service.

In addition, when the terminal device sends the data resource information of the AI service, the data resource information sent by the terminal device may include local initial data resource information. Therefore, the network device can participate in AI computing based on the initial data resource information. Alternatively, after the network device performs data processing (for example, redundant data deletion or data augmentation) on local initial data of the terminal device, the network device sends processed data to the terminal device, so that the terminal device can perform AI computing based on the processed data.

In a possible implementation of the first aspect, before the terminal device receives the configuration information of the AI service, the method further includes: The terminal device sends capability information, where the capability information includes at least one of the local data service capability information of the terminal device, the local computing service capability information of the terminal device, the local sensing service capability information of the terminal device, and the local connection service capability information of the terminal device. The terminal device receives a response to the capability information.

According to the foregoing technical solution, before the terminal device receives the configuration information of the AI service, the terminal device may further send the capability information of the terminal device, so that the network device learns an AI-related capability of the terminal device.

Optionally, the configuration information of the AI service is determined based on the capability information, so that the configuration information provided by the network device can adapt to the capability of the terminal device.

In a possible implementation of the first aspect, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

According to the foregoing technical solution, the capability information and the response to the capability information can be implemented in any one of the foregoing manners, to improve flexibility of implementing the solution.

A second aspect of this application provides a communication method. The method is performed by a first network device. Alternatively, the method is performed by a part of components (for example, a processor, a chip, or a chip system) in a first network device. Alternatively, the method may be implemented by a logical module or software that can implement all or a part of functions of a first network device. In the second aspect and possible implementations of the second aspect, an example in which the method is performed by the first network device is used for description. In the method, the first network device sends configuration information of an artificial intelligence AI service, where the configuration information of the AI service indicates configuration information of a connection function and at least one of the following: an identifier of the AI service, configuration information of a computing function, configuration information of a sensing function, or configuration information of a data function. The first network device receives or sends service information of the AI service based on the configuration information of the AI service.

According to the foregoing technical solution, in addition to indicating the configuration information of the connection function, the configuration information of the AI service sent by the first network device further indicates at least one of the identifier of the AI service, the configuration information of the computing function, the configuration information of the sensing function, and the configuration information of the data function. Therefore, after a terminal device receives the configuration information of the AI service, the terminal device can receive or send the service information of the AI service based on the configuration information of the connection function and the at least one piece of configuration information. In this way, the network device provides the configuration information of the AI service, so that the first network device can transmit the service information of the AI service based on the configuration information of the AI service, to implement integration of AI computing power and a communication network.

It should be noted that the configuration information of the AI service may be used for one or more AI service instances (or referred to as one or more AI services, or referred to as one or more AI tasks, or the like). The AI service instance (or the AI service, the AI task, or the like) may include: a single network device providing an AI training service, a plurality of network devices providing an AI training service, AI split-learning, AI federated learning, or other implementations. This is not limited herein.

Optionally, the configuration information of the connection function indicated by the configuration information of the AI service includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Therefore, the terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

Optionally, the configuration information of the computing function indicated by the configuration information of the AI service is for AI model training and/or AI model inference. Therefore, the terminal device can participate in an AI computing process in the AI service scenario based on the configuration information of the AI service.

Optionally, the configuration information of the sensing function indicated by the configuration information of the AI service is for environment parameter measurement and/or environment parameter reporting. Therefore, the terminal device can implement an environment sensing process in the AI service scenario based on the configuration information of the AI service.

Optionally, the configuration information of the data function indicated by the configuration information of the AI service is used to collect data and/or augment data. Therefore, the terminal device can implement an AI data processing process in the AI service scenario based on the configuration information of the AI service.

In a possible implementation of the second aspect, a part or all of the service information of the AI service is carried on a physical downlink shared channel PDSCH, and control information associated with the PDSCH indicates the AI service.

The service information of the AI service transmitted based on the configuration information of the AI service may be carried on the PDSCH, and the control information associated with the PDSCH indicates the AI service, so that the terminal device can identify, based on the control information, information carried on the PDSCH.

Optionally, the control information is downlink control information (downlink control information, DCI) or a media access control control element (media access control control element, MAC CE) transmitted on a physical downlink control channel (physical downlink control channel, PDCCH).

In a possible implementation of the second aspect, before the first network device sends the configuration information of the AI service, the method further includes: The first network device receives request information used to request the AI service.

According to the foregoing technical solution, the first network device may receive the request information used to request the AI service, so that the first network device sends the configuration information of the AI service based on the request information. Therefore, the foregoing technical solution is applicable to a scenario in which the terminal device requests the AI service.

In a possible implementation of the second aspect, the request information includes at least one of the following: local data resource information of the terminal device, motion status information of the terminal device, local data service capability information of the terminal device, local computing service capability information of the terminal device, local sensing service capability information of the terminal device, local connection service capability information of the terminal device, service type description information of the AI service, or service target description information of the AI service.

According to the foregoing technical solution, the request information sent by the terminal device may include at least one of the foregoing items, so that the network device sends, based on the at least one item, the configuration information of the AI service corresponding to the request information.

In a possible implementation of the second aspect, that the first network device receives or sends the service information of the AI service based on the configuration information of the AI service includes: The first network device receives or sends data resource information of the AI service based on the configuration information of the AI service.

According to the foregoing technical solution, in a process in which the first network device receives or sends the service information of the AI service based on the configuration information of the AI service, the first network device may send the data resource information of the AI service, so that the terminal device locally performs AI computing based on the data resource information of the AI service.

In addition, when the first network device receives the data resource information of the AI service, the data resource information received by the first network device may include local initial data resource information of the terminal device. Therefore, the first network device can participate in AI computing based on the initial data resource information. Alternatively, after the first network device performs data processing (for example, redundant data deletion or data augmentation) on local initial data of the terminal device, the first network device sends processed data to the terminal device, so that the terminal device can perform AI computing based on the processed data.

In a possible implementation of the second aspect, before the first network device sends the configuration information of the AI service, the method further includes: The first network device receives capability information, where the capability information includes at least one of the local data service capability information of the terminal device, the local computing service capability information of the terminal device, the local sensing service capability information of the terminal device, or the local connection service capability information of the terminal device. The first network device sends a response to the capability information.

According to the foregoing technical solution, before the first network device sends the configuration information of the AI service, the first network device may further receive the capability information of the terminal device, so that the first network device learns an AI-related capability of the terminal device.

Optionally, the configuration information of the AI service is determined based on the capability information, so that the configuration information provided by the first network device can adapt to the capability of the terminal device.

In a possible implementation of the second aspect, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

According to the foregoing technical solution, the capability information and the response to the capability information can be implemented in any one of the foregoing manners, to improve flexibility of implementing the solution.

In a possible implementation of the second aspect, the method further includes: The first network device sends, to a second network device, indication information indicating the capability information.

According to the foregoing technical solution, after the first network device receives the capability information from the terminal device, the first network device may further send, to the second network device, the indication information indicating the capability information, so that another network device can learn an AI-related capability of a terminal device connected to the first network device, to implement AI collaboration across network devices.

In a possible implementation of the second aspect, before the first network device sends the configuration information of the AI service, the method further includes: The first network device receives first information from the second network device, where the first information indicates an AI service capability of the second network device. The first network device determines the configuration information of the AI service based on the first information.

According to the foregoing technical solution, the first network device may further receive, from the second network device, the first information indicating the AI service capability of the second network device, and the first network device determines the configuration information of the AI service based on the first information. Therefore, the first network device can serve as a decision party for AI computing power of a plurality of network devices to schedule and configure the AI computing power of the plurality of network devices, making the solution applicable to a scenario in which the plurality of network devices participate in AI collaboration.

In a possible implementation of the second aspect, before the first network device sends the configuration information of the AI service, the method further includes: The first network device sends second information to the second network device, where the second information indicates an AI service capability of the first network device and/or is used to request the AI service. The first network device receives the configuration information of the AI service.

According to the foregoing technical solution, the first network device may further send, to the second network device, the second information that indicates the AI service capability of the first network device and/or is used to request the AI service, and the first network device receives the configuration information of the AI service. Therefore, the second network device can serve as a decision party for AI computing power of a plurality of network devices to schedule and configure the AI computing power of the plurality of network devices, making the solution applicable to a scenario in which the plurality of network devices participate in AI collaboration, to provide an AI service across network devices.

In a possible implementation of the second aspect, the AI service capability includes at least one of the following: a data service capability, a computing service capability, a sensing service capability, and a connection service capability.

According to the foregoing technical solution, AI service capabilities exchanged between different network devices may include at least one of the foregoing items, to provide a flexible configuration of the AI service.

In a possible implementation of the second aspect, a part or all of the service information of the AI service is service information between the terminal device and the another network device.

According to the foregoing technical solution, in a scenario in which the first network device connected to the terminal device provides a part or all of the AI service for the terminal device via the another network device, the first network device can serve as a transmission relay between the terminal device and the another network device to receive or send the service information between the terminal device and the another network device.

Optionally, a part or all of the service information of the AI service is service information between the terminal device and the first network device.

In a possible implementation of the first aspect or the second aspect, the service information of the AI service includes at least one of the following: an AI computing result of the first network device, an AI computing result of the terminal device connected to the first network device, an AI computing result of the another network device, and an AI computing result of a terminal device connected to the another network device.

According to the foregoing technical solution, the service information of the AI service received or sent by the first network device may include at least one of the foregoing items, so that the solution is applicable to an application scenario in which a plurality of communication nodes (including at least one communication node of the terminal device, the first network device, and the another network device) provide AI computing power.

A third aspect of this application provides a communication method. The method is performed by a first network device and a second network device. Alternatively, the method is performed by a part of components (for example, a processor, a chip, or a chip system) in a first network device and a second network device. Alternatively, the method may be implemented by a logical module or software that can implement all or a part of functions of a first network device and a second network device. In the third aspect and possible implementations of the third aspect, an example in which the method is performed by the first network device and the second network device is used for description. In the method, the second network device sends first information, where the first information indicates an AI service capability of the second network device. The first network device receives the first information from the second network device. The first network device determines configuration information of an AI service for the first network device and configuration information of the AI service for the second network device based on the first information, where the configuration information of the AI service indicates configuration information of a connection function and at least one of the following: an identifier of the AI service, configuration information of a computing function, configuration information of a sensing function, and configuration information of a data function.

According to the foregoing technical solution, after the first network device receives, from the second network device, the first information indicating the AI service capability of the second network device, the first network device determines the configuration information of the AI service for the first network device and the configuration information of the AI service for the second network device based on the first information. In addition to indicating the configuration information of the connection function, the configuration information of the AI service further indicates at least one of the identifier of the AI service, the configuration information of the computing function, the configuration information of the sensing function, and the configuration information of the data function. Therefore, the first network device receives or sends service information of the AI service based on the configuration information of the connection function and the at least one piece of configuration information. In this way, capabilities are exchanged between different network devices to provide the configuration information of the AI service, so that the first network device can subsequently transmit the service information of the AI service based on the configuration information of the AI service, to implement integration of AI computing power and a communication network.

In addition, the first network device can serve as a decision party for AI computing power of a plurality of network devices to schedule and configure the AI computing power of the plurality of network devices, making the solution applicable to a scenario in which the plurality of network devices participate in AI collaboration.

In a possible implementation of the third aspect, the method further includes: The first network device sends the configuration information of the AI service for the second network device. The second network device receives the configuration information of the AI service for the second network device.

According to the foregoing technical solution, the second network device may further receive the configuration information of the AI service for the second network device from the first network device, so that the first network device can serve as the decision party for the AI computing power of the plurality of network devices to schedule and configure the AI computing power of the plurality of network devices.

In a possible implementation of the third aspect, the method further includes: The second network device sends third information, where the third information indicates that the configuration information of the AI service for the second network device is confirmed. The first network device receives the third information.

According to the foregoing technical solution, the first network device may further receive the third information indicating that the configuration information of the AI service for the second network device is confirmed, so that the first network device determines, based on the third information, that the second network device has successfully received the configuration information of the AI service for the second network device, and subsequently, a terminal device connected to the first network device can obtain the AI service provided by the first network device and the second network device.

In a possible implementation of the third aspect, the method further includes: The second network device sends the service information of the AI service to the terminal device via the first network device or receives the service information of the AI service from the terminal device via the first network device based on the configuration information of the AI service for the second network device.

According to the foregoing technical solution, in a process in which the second network device provides the AI service for the terminal device connected to the first network device, the first network device can serve as a transmission relay to receive or send the service information of the AI service between the second network device and the terminal device based on the configuration information of the AI service for the second network device.

In a possible implementation of the third aspect, the method further includes: The first network device sends the service information of the AI service to the terminal device or receives the service information of the AI service from the terminal device based on the configuration information of the AI service for the first network device.

According to the foregoing technical solution, in a process in which the first network device provides the AI service for the terminal device connected to the first network device, the service information of the AI service may be received or sent between the first network device and the terminal device based on the configuration information of the AI service for the first network device.

A fourth aspect of this application provides a communication method. The method is performed by a first network device and a second network device. Alternatively, the method is performed by a part of components (for example, a processor, a chip, or a chip system) in a first network device and a second network device. Alternatively, the method may be implemented by a logical module or software that can implement all or a part of functions of a first network device and a second network device. In the fourth aspect and possible implementations of the fourth aspect, an example in which the method is performed by the first network device and the second network device is used for description. In the method, the second network device sends first information, where the first information indicates an AI service capability of the second network device and/or is used to request an AI service. The first network device receives the first information from the second network device. The first network device determines configuration information of the AI service for the second network device based on the first information, where the configuration information of the AI service indicates configuration information of a connection function and at least one of the following: an identifier of the AI service, configuration information of a computing function, configuration information of a sensing function, and configuration information of a data function.

According to the foregoing technical solution, after the first network device receives, from the second network device, the first information indicating the AI service capability of the second network device, the first network device determines the configuration information of the AI service for the second network device based on the first information. In addition to indicating the configuration information of the connection function, the configuration information of the AI service further indicates at least one of the identifier of the AI service, the configuration information of the computing function, the configuration information of the sensing function, and the configuration information of the data function. Therefore, the first network device receives or sends service information of the AI service based on the configuration information of the connection function and the at least one piece of configuration information. In this way, capabilities are exchanged between different network devices to provide the configuration information of the AI service, so that the second network device can subsequently transmit the service information of the AI service based on the configuration information of the AI service, to implement integration of AI computing power and a communication network.

In addition, the first network device can serve as a decision party for AI computing power of a plurality of network devices to schedule and configure AI computing power of another network device (for example, the second network device).

In a possible implementation of the fourth aspect, the method further includes: The first network device sends the configuration information of the AI service for the second network device. The second network device receives the configuration information of the AI service for the second network device.

According to the foregoing technical solution, the second network device may further receive the configuration information of the AI service for the second network device from the first network device, so that the first network device can serve as the decision party for the AI computing power of the plurality of network devices to schedule and configure the AI computing power of the another network device (for example, the second network device).

In a possible implementation of the fourth aspect, the method further includes: The second network device sends third information, where the third information indicates that the configuration information of the AI service for the second network device is confirmed. The first network device receives the third information.

According to the foregoing technical solution, the first network device may further receive the third information indicating that the configuration information of the AI service for the second network device is confirmed, so that the first network device determines, based on the third information, that the second network device has successfully received the configuration information of the AI service for the second network device, and subsequently, a terminal device connected to the first network device can obtain the AI service provided by the second network device.

In a possible implementation of the fourth aspect, the method further includes: The second network device sends the service information of the AI service to the terminal device or receives the service information of the AI service from the terminal device based on the configuration information of the AI service for the second network device.

According to the foregoing technical solution, in a process in which the second network device provides the AI service for the terminal device connected to the first network device, the first network device can serve as a transmission relay to receive or send the service information of the AI service between the second network device and the terminal device based on the configuration information of the AI service for the second network device.

In a possible implementation of the fourth aspect, the method further includes: The first network device determines configuration information of the AI service for the first network device based on the first information. The first network device sends the service information of the AI service to the terminal device via the second network device or receives the service information of the AI service from the terminal device via the second network device based on the configuration information of the AI service for the first network device.

According to the foregoing technical solution, the first network device may further determine the configuration information of the AI service for the first network device based on the first information, so that the first network device can serve as the decision party for the AI computing power of the plurality of network devices to schedule and configure the AI computing power of the plurality of network devices, making the solution applicable to a scenario in which the plurality of network devices participate in AI collaboration.

In addition, in a process in which the first network device provides the AI service for a terminal device connected to the second network device, the second network device can serve as a transmission relay to receive or send the service information of the AI service between the first network device and the terminal device based on the configuration information of the AI service for the first network device.

In a possible implementation of the fourth aspect, the method further includes: The first network device receives fourth information from a third network device, where the fourth information indicates an AI service capability of the third network device. That the first network device determines the configuration information of the AI service for the second network device based on the first information includes: The first network device determines the configuration information of the AI service for the second network device and configuration information of the AI service for the third network device based on the first information and the fourth information. The first network device sends the configuration information of the AI service for the third network device to the third network device. The third network device sends the service information of the AI service to the terminal device via the second network device or receives the service information of the AI service from the terminal device via the second network device based on the configuration information of the AI service for the third network device.

According to the foregoing technical solution, the first network device may further determine the configuration information of the AI service for the first network device based on the first information, so that the first network device can serve as the decision party for the AI computing power of the plurality of network devices to schedule and configure the AI computing power of the plurality of network devices, making the solution applicable to the scenario in which the plurality of network devices participate in AI collaboration.

In addition, in a process in which the third network device provides the AI service for a terminal device connected to the second network device, the second network device can serve as a transmission relay to receive or send the service information of the AI service between the third network device and the terminal device based on the configuration information of the AI service for the third network device.

In a possible implementation of the third aspect or the fourth aspect, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Therefore, the terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

In a possible implementation of the third aspect or the fourth aspect, the configuration information of the computing function is for AI model training and/or AI model inference. Therefore, the terminal device can participate in an AI computing process in the AI service scenario based on the configuration information of the AI service.

In a possible implementation of the third aspect or the fourth aspect, the configuration information of the sensing function is for environment parameter measurement and/or environment parameter reporting.

In a possible implementation of the third aspect or the fourth aspect, the configuration information of the data function is used to collect data and/or augment data. Therefore, the terminal device can implement an environment sensing process in the AI service scenario based on the configuration information of the AI service.

In a possible implementation of the third aspect or the fourth aspect, the AI service capability includes at least one of the following: a data service capability, a computing service capability, a sensing service capability, and a connection service capability. Therefore, the terminal device can implement an AI data processing process in the AI service scenario based on the configuration information of the AI service.

In a possible implementation of the third aspect or the fourth aspect, the service information of the AI service includes at least one of the following: an AI computing result of the first network device, an AI computing result of the terminal device connected to the first network device, an AI computing result of the another network device, and an AI computing result of a terminal device connected to the another network device.

According to the foregoing technical solution, the service information of the AI service received or sent by the terminal device may include at least one of the foregoing items, so that the solution is applicable to an application scenario in which a plurality of communication nodes (including at least one communication node of the terminal device, the first network device, and the another network device) provide AI computing power.

A fifth aspect of this application provides a communication apparatus. The apparatus is a terminal device. Alternatively, the apparatus is a part of components (for example, a processor, a chip, or a chip system) in a terminal device. Alternatively, the apparatus may be a logical module or software that can implement all or a part of functions of a terminal device. In the fifth aspect and possible implementations of the fifth aspect, an example in which the communication apparatus is the terminal device is used for description.

The apparatus includes a processing unit and a transceiver unit. The transceiver unit is configured to receive configuration information of an artificial intelligence AI service, where the configuration information of the AI service indicates configuration information of a connection function and at least one of the following: an identifier of the AI service, configuration information of a computing function, configuration information of a sensing function, and configuration information of a data function. The processing unit is configured to receive or send, via the transceiver unit, service information of the AI service based on the configuration information of the AI service.

In a possible implementation of the fifth aspect, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, and configuration information of a physical PHY layer. Alternatively, the configuration information of the computing function is for AI model training and/or AI model inference. Alternatively, the configuration information of the sensing function is for environment parameter measurement and/or environment parameter reporting. Alternatively, the configuration information of the data function is used to collect data and/or augment data.

In a possible implementation of the fifth aspect, a part or all of the service information of the AI service is carried on a physical downlink shared channel PDSCH, and control information associated with the PDSCH indicates the AI service.

In a possible implementation of the fifth aspect, the control information is downlink control information DCI or a media access control control element MAC CE transmitted on a physical downlink control channel PDCCH.

In a possible implementation of the fifth aspect, the transceiver unit is further configured to send request information used to request the AI service.

In a possible implementation of the fifth aspect, the request information includes at least one of the following: local data resource information of the terminal device, motion status information of the terminal device, local data service capability information of the terminal device, local computing service capability information of the terminal device, local sensing service capability information of the terminal device, local connection service capability information of the terminal device, service type description information of the AI service, and service target description information of the AI service.

In a possible implementation of the fifth aspect, the processing unit is specifically configured to receive or send, via the transceiver unit, data resource information of the AI service based on the configuration information of the AI service.

In a possible implementation of the fifth aspect, the transceiver unit is further configured to send capability information, where the capability information includes at least one of the local data service capability information of the terminal device, the local computing service capability information of the terminal device, the local sensing service capability information of the terminal device, and the local connection service capability information of the terminal device. The transceiver unit is further configured to receive a response to the capability information.

In a possible implementation of the fifth aspect, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

In the fifth aspect of embodiments of this application, the component modules of the communication apparatus may be further configured to perform the steps performed in the possible implementations of the first aspect, and achieve corresponding technical effects. For details, refer to the first aspect. The details are not described herein again.

A sixth aspect of this application provides a communication apparatus. The apparatus is a first network device. Alternatively, the apparatus is a part of components (for example, a processor, a chip, or a chip system) in a first network device. Alternatively, the apparatus may be a logical module or software that can implement all or a part of functions of a first network device. In the sixth aspect and possible implementations of the sixth aspect, an example in which the communication apparatus is the first network device is used for description.

The apparatus includes a processing unit and a transceiver unit. The transceiver unit is configured to send configuration information of an artificial intelligence AI service, where the configuration information of the AI service indicates configuration information of a connection function and at least one of the following: an identifier of the AI service, configuration information of a computing function, configuration information of a sensing function, or configuration information of a data function. The processing unit is configured to receive or send, via the transceiver unit, service information of the AI service based on the configuration information of the AI service.

In a possible implementation of the sixth aspect, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Alternatively, the configuration information of the computing function is for AI model training and/or AI model inference. Alternatively, the configuration information of the sensing function is for environment parameter measurement and/or environment parameter reporting. Alternatively, the configuration information of the data function is used to collect data and/or augment data.

In a possible implementation of the sixth aspect, a part or all of the service information of the AI service is carried on a physical downlink shared channel PDSCH, and control information associated with the PDSCH indicates the AI service.

In a possible implementation of the sixth aspect, the control information is downlink control information DCI or a media access control control element MAC CE transmitted on a physical downlink control channel PDCCH.

In a possible implementation of the sixth aspect, the transceiver unit is further configured to receive request information used to request the AI service.

In a possible implementation of the sixth aspect, the request information includes at least one of the following: local data resource information of a terminal device, motion status information of the terminal device, local data service capability information of the terminal device, local computing service capability information of the terminal device, local sensing service capability information of the terminal device, local connection service capability information of the terminal device, service type description information of the AI service, or service target description information of the AI service.

In a possible implementation of the sixth aspect, the processing unit is specifically configured to receive or send, via the transceiver unit, data resource information of the AI service based on the configuration information of the AI service.

In a possible implementation of the sixth aspect, the transceiver unit is further configured to receive capability information, where the capability information includes at least one of the local data service capability information of the terminal device, the local computing service capability information of the terminal device, the local sensing service capability information of the terminal device, or the local connection service capability information of the terminal device. The transceiver unit is further configured to send a response to the capability information.

In a possible implementation of the sixth aspect, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

In a possible implementation of the sixth aspect, the transceiver unit is further configured to send, to a second network device, indication information indicating the capability information.

In a possible implementation of the sixth aspect, the transceiver unit is further configured to receive first information from the second network device, where the first information indicates an AI service capability of the second network device. The processing unit is further configured to determine the configuration information of the AI service based on the first information.

In a possible implementation of the sixth aspect, the transceiver unit is further configured to send second information to the second network device, where the second information indicates an AI service capability of the first network device and/or is used to request the AI service. The transceiver unit is further configured to receive the configuration information of the AI service.

In a possible implementation of the sixth aspect, the AI service capability includes at least one of the following: a data service capability, a computing service capability, a sensing service capability, and a connection service capability.

In a possible implementation of the sixth aspect, a part or all of the service information of the AI service is service information between the terminal device and another network device.

In a possible implementation of the sixth aspect, the service information of the AI service includes at least one of the following: an AI computing result of the first network device, an AI computing result of a terminal device connected to the first network device, an AI computing result of the another network device, and an AI computing result of a terminal device connected to the another network device.

In the sixth aspect of embodiments of this application, the component modules of the communication apparatus may be further configured to perform the steps performed in the possible implementations of the second aspect, and achieve corresponding technical effects. For details, refer to the second aspect. The details are not described herein again.

A seventh aspect of this application provides a communication apparatus, including at least one processor. The at least one processor is coupled to a memory. The memory is configured to store a program or instructions. The at least one processor is configured to execute the program or the instructions, so that the apparatus implements the method according to any one of the first aspect or the possible implementations of the first aspect.

An eighth aspect of this application provides a communication apparatus, including at least one processor. The at least one processor is coupled to a memory. The memory is configured to store a program or instructions. The at least one processor is configured to execute the program or the instructions, so that the apparatus implements the method according to any one of the second aspect or the possible implementations of the second aspect.

A ninth aspect of embodiments of this application provides a communication apparatus, including at least one logic circuit and an input/output interface. The logic circuit is configured to perform the method according to any one of the first aspect or the possible implementations of the first aspect.

A tenth aspect of embodiments of this application provides a communication apparatus, including at least one logic circuit and an input/output interface. The logic circuit is configured to perform the method according to any one of the second aspect or the possible implementations of the second aspect.

An eleventh aspect of embodiments of this application provides a communication system. The communication system includes the communication apparatus according to the fifth aspect and the communication apparatus according to the sixth aspect; and/or the communication system includes the communication apparatus according to the seventh aspect and the communication apparatus according to the eighth aspect; and/or the communication system includes the communication apparatus according to the ninth aspect and the communication apparatus according to the tenth aspect.

A twelfth aspect of embodiments of this application provides a communication system. The communication system includes a first network device and a second network device. The first network device and the second network device are configured to perform the method according to any one of the third aspect or the fourth aspect and embodiments of the third aspect or the fourth aspect. Optionally, the communication system further includes a third network device.

A thirteenth aspect of embodiments of this application provides a computer-readable storage medium storing one or more computer-executable instructions. When the computer-executable instructions are executed by a processor, the processor performs the method according to any possible implementation of any one of the first aspect to the fourth aspect.

A fourteenth aspect of embodiments of this application provides a computer program product (or referred to as a computer program) storing one or more computer-executable instructions. When the computer program product is executed by a processor, the processor performs the method according to any possible implementation of any one of the first aspect to the fourth aspect.

A fifteenth aspect of embodiments of this application provides a chip system. The chip system includes at least one processor, configured to support a communication apparatus in implementing the method according to any possible implementation of any one of the first aspect to the fourth aspect.

In a possible design, the chip system may further include a memory. The memory is configured to store program instructions and data that are necessary for the communication apparatus. The chip system may include a chip, or may include a chip and another discrete component. Optionally, the chip system further includes an interface circuit, and the interface circuit provides program instructions and/or data for the at least one processor.

For technical effects brought by any design manner in the fifth aspect to the fifteenth aspect, refer to the technical effects brought by different design manners in the first aspect to the fourth aspect. Details are not described herein again.

It can be learned from the foregoing technical solutions that the solutions provided in this application have the following beneficial effects.

In some implementations, in addition to indicating the configuration information of the connection function, the configuration information of the AI service received by the terminal device further indicates at least one of the identifier of the AI service, the configuration information of the computing function, the configuration information of the sensing function, and the configuration information of the data function. Therefore, the terminal device receives or sends the service information of the AI service based on the configuration information of the connection function and the at least one piece of configuration information. In this way, the network device provides the configuration information of the AI service, so that the terminal device can transmit the service information of the AI service based on the configuration information of the AI service, to implement integration of the AI computing power and the communication network.

Further, in some other implementations, after the first network device receives, from the second network device, the first information indicating the AI service capability of the second network device, the first network device determines the configuration information of the AI service for the first network device and the configuration information of the AI service for the second network device based on the first information. In addition to indicating the configuration information of the connection function, the configuration information of the AI service further indicates at least one of the identifier of the AI service, the configuration information of the computing function, the configuration information of the sensing function, and the configuration information of the data function. Therefore, the first network device receives or sends the service information of the AI service based on the configuration information of the connection function and the at least one piece of configuration information. In this way, capabilities are exchanged between different network devices to provide the configuration information of the AI service, so that the first network device can subsequently transmit the service information of the AI service based on the configuration information of the AI service, to implement integration of the AI computing power and the communication network. In addition, the first network device can serve as the decision party for the AI computing power of the plurality of network devices to schedule and configure the AI computing power of the plurality of network devices, making the solution applicable to the scenario in which the plurality of network devices participate in AI collaboration.

### BRIEF DESCRIPTION OF DRAWINGS

FIG. 1a is a diagram of a communication system according to this application;

FIG. 1b is another diagram of a communication system according to this application;

FIG. 2 is a diagram of interaction in a communication method according to this application;

FIG. 3 is another diagram of a communication system according to this application;

FIG. 4a is a diagram of interaction in a communication method according to this application;

FIG. 4b is a diagram of interaction in a communication method according to this application;

FIG. 4c is a diagram of interaction in a communication method according to this application;

FIG. 4d is another diagram of a communication system according to this application;

FIG. 5a is a diagram of interaction in a communication method according to this application;

FIG. 5b is a diagram of interaction in a communication method according to this application;

FIG. 5c is a diagram of interaction in a communication method according to this application;

FIG. 6 is a diagram of interaction in a communication method according to this application;

FIG. 7 is a diagram of interaction in a communication method according to this application;

FIG. 8 is a diagram of a communication apparatus according to this application;

FIG. 9 is another diagram of a communication apparatus according to this application;

FIG. 10 is another diagram of a communication apparatus according to this application; and

FIG. 11 is another diagram of a communication apparatus according to this application.

### DESCRIPTION OF EMBODIMENTS

First, a part of terms in embodiments of this application are explained to facilitate understanding of a person skilled in the art.

(1) Terminal device: may be a wireless terminal device that can receive scheduling and indication information of a network device. The wireless terminal device may be a device providing voice and/or data connectivity for a user, a handheld device having a wireless connection function, or another processing device connected to a wireless modem.

The terminal device may communicate with one or more core networks or an internet through a RAN. The terminal device may be a mobile terminal device such as a mobile phone (or referred to as a “cellular” phone or a mobile phone (mobile phone)), a computer, or a data card. For example, the terminal device may be a portable, pocket-sized, handheld, computer built-in, or in-vehicle mobile apparatus that exchanges voice and/or data with the radio access network. For example, the terminal device may be a device such as a personal communication service (personal communication service, PCS) phone, a cordless phone, a session initiation protocol (SIP) phone, a wireless local loop (wireless local loop, WLL) station, a personal digital assistant (personal digital assistant, PDA), a tablet computer (Pad), or a computer having a wireless transceiver function. The wireless terminal device may also be referred to as a system, a subscriber unit (subscriber unit), a subscriber station (subscriber station), a mobile station (mobile station, MS), a remote station (remote station), an access point (access point, AP), a remote terminal device (remote terminal), an access terminal device (access terminal), a user terminal device (user terminal), a user agent (user agent), a subscriber station (subscriber station, SS), customer premises equipment (customer premises equipment, CPE), a terminal (terminal), user equipment (user equipment, UE), a mobile terminal (mobile terminal, MT), or the like.

By way of example, and not limitation, in embodiments of this application, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that can be directly worn on a body or integrated into clothes or an accessory of a user. The wearable device is not only a hardware device, but also implements a powerful function through software support, data exchange, and cloud interaction. In a broad sense, the wearable intelligent device includes a full-featured and large-sized device that can implement all or a part of functions without depending on a smartphone, for example, a smart watch or smart glasses, and includes a device that is dedicated to only one type of application function and needs to collaboratively work with another device such as a smartphone, for example, various smart bands, smart helmets, or smart jewelry for monitoring physical signs.

The terminal may alternatively be an uncrewed aerial vehicle, a robot, a terminal in device-to-device (device-to-device, D2D) communication, a terminal in vehicle-to-everything (vehicle-to-everything, V2X), a virtual reality (virtual reality, VR) terminal device, an augmented reality (augmented reality, AR) terminal device, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), or the like.

In addition, the terminal device may be a terminal device in an evolved communication system (for example, a 6th generation (6th generation, 6G) communication system) after a 5th generation (5th generation, 5G) communication system, a terminal device in a future evolved public land mobile network (public land mobile network, PLMN), or the like. For example, a 6G network may further extend a form and a function of a 5G communication terminal, and a 6G terminal includes but is not limited to a vehicle, a cellular network terminal (integrating a function of a satellite terminal), an uncrewed aerial vehicle, and an internet of things (internet of things, IoT) device.

In embodiments of this application, the terminal device may further obtain an AI service provided by a network device. Optionally, the terminal device may further have an AI processing capability.

(2) Network device: may be a device in a wireless network. For example, the network device may be a RAN node (or device) connecting a terminal device to the wireless network, and may also be referred to as a base station. Currently, some examples of the RAN device are: a base station gNB (gNodeB) in a 5G communication system, a transmission reception point (transmission reception point, TRP), an evolved NodeB (evolved NodeB, eNB), a radio network controller (radio network controller, RNC), a NodeB (NodeB, NB), a home base station (for example, a home evolved NodeB or a home NodeB, HNB), a baseband unit (baseband unit, BBU), or a wireless fidelity (wireless fidelity, Wi-Fi) access point AP. In addition, in a network structure, the network device may include a central unit (central unit, CU) node, a distributed unit (distributed unit, DU) node, a CU-control plane (control plane, CP), a CU-user plane (user plane, UP), a radio unit (radio unit, RU), or a RAN device including a CU node and a DU node. The CU and the DU may be separately arranged, or may be included in a same network element, for example, the baseband unit (baseband unit, BBU). The RU may be included in a radio frequency device or a radio frequency unit, for example, included in a remote radio unit (remote radio unit, RRU), an active antenna unit (active antenna unit, AAU), or a remote radio head (remote radio head, RRH). In different systems, the CU (or the CU-CP and the CU-UP), the DU, or the RU may alternatively have different names, but a person skilled in the art may understand meanings thereof. For example, in an ORAN system, the CU may also be referred to as an open CU (O-CU), the DU may also be referred to as an open DU (O-DU), the CU-CP may also be referred to as an open CU-CP (O-CU-CP), the CU-UP may also be referred to as an open CU-UP (O-CU-UP), and the RU may also be referred to as an open RU (O-RU). Any one of the CU (or the CU-CP and the CU-UP), the DU, and the RU may be implemented by using a software module, a hardware module, or a combination of a software module and a hardware module.

The network device may be another apparatus that provides a wireless communication function for the terminal device. A specific technology and a specific device form that are used by the network device are not limited in embodiments of this application. For ease of description, this is not limited in embodiments of this application.

The network device may further include a core network device. For example, the core network device includes network elements such as a mobility management entity (mobility management entity, MME), a home subscriber server (home subscriber server, HSS), a serving gateway (serving gateway, S-GW), a policy and charging rules function (policy and charging rules function, PCRF), and a public data network gateway (public data network gateway, PDN gateway, P-GW) in a 4th generation (4th generation, 4G) network, and an access and mobility management function (access and mobility management function, AMF), a user plane function (user plane function, UPF), or a session management function (session management function, SMF) in a 5G network. In addition, the core network device may further include another core network device in the 5G network and a next generation network of the 5G network.

In embodiments of this application, the network device may alternatively be a network node having an AI capability, and may provide an AI service for a terminal or another network device, for example, may be an AI node, a computing power node, a RAN node having an AI capability, or a core network element having an AI capability on a network side (an access network or a core network).

In embodiments of this application, an apparatus configured to implement a function of the network device may be the network device, or may be an apparatus, for example, a chip system, that can support the network device in implementing the function. The apparatus may be installed in the network device. In the technical solutions provided in embodiments of this application, an example in which the apparatus configured to implement the function of the network device is the network device is used to describe the technical solutions provided in embodiments of this application.

(3) Configuration and preconfiguration: In this application, both the configuration and the preconfiguration are used. The configuration means that a network device/server sends configuration information of some parameters or values of parameters to a terminal by using a message or signaling, so that the terminal determines, based on the values or the information, a communication parameter or a resource for transmission. Similar to the configuration, the preconfiguration may be parameter information or a parameter value negotiated by a network device/server with a terminal device in advance, or may be parameter information or a parameter value that is used by a base station/network device or a terminal device and that is specified in a standard protocol, or may be parameter information or a parameter value pre-stored in a base station/server or a terminal device. This is not limited in this application.

Further, these values and parameters may be changed or updated.

(4) Terms “system” and “network” in embodiments of this application may be used interchangeably. “A plurality of” means two or more than two. The term “and/or” describes an association relationship between associated objects, and indicates that three relationships may exist. For example, A and/or B may indicate the following three cases: Only A exists, both A and B exist, and only B exists, where A and B may be singular or plural. The character “/” generally indicates an “or” relationship between the associated objects. At least one of the following items (pieces) or a similar expression thereof indicates any combination of these items, including a single item (piece) or any combination of a plurality of items (pieces). For example, “at least one of A, B, and C” includes A, B, C, AB, AC, BC, or ABC. In addition, unless otherwise specified, ordinal numbers such as “first” and “second” in embodiments of this application are used to distinguish between a plurality of objects, and are not used to limit a sequence, a time sequence, a priority, or importance of the plurality of objects.

(5) To clearly describe the technical solutions in embodiments of this application, terms such as “first” and “second” are used in embodiments of this application to distinguish between same items or similar items that have basically same functions and effects. For example, first information and second information are merely used to distinguish between different information. A person skilled in the art may understand that the terms such as “first” and “second” do not limit a quantity and an execution sequence.

(6) “Sending” and “receiving” in embodiments of this application represent signal transfer directions. For example, “sending information to a terminal device” may be understood as that a destination end of the information is the terminal device, and may include direct sending through an air interface, or indirect sending by another unit or module through an air interface. “Receiving information from a network device” may be understood as that a source end of the information is the network device, and may include direct receiving from the network device through an air interface, or indirect receiving from the network device from another unit or module through an air interface. “Sending” may alternatively be understood as “outputting” of a chip interface, and “receiving” may alternatively be understood as “inputting” of the chip interface. In other words, sending and receiving may be performed between devices, for example, between the network device and the terminal device, or may be performed in a device, for example, sending or receiving is performed between components, modules, chips, software modules, or hardware modules in the device through a bus, a cable, or an interface. It may be understood that necessary processing, for example, encoding and modulation, may be performed on information between a source end and a destination end of information sending, but the destination end may understand effective information from the source end. Similar descriptions in this application may be understood similarly. Details are not described again.

In this application, for same or similar parts of embodiments, mutual reference may be made between embodiments, unless otherwise specified. In embodiments of this application and methods/designs/implementations in embodiments, unless otherwise specified or logic conflicts occur, terms and/or descriptions between different embodiments and between the methods/designs/implementations in embodiments are consistent and may be mutually referenced. Technical features in different embodiments and the methods/designs/implementations in embodiments may be combined to form a new embodiment, method, or implementation based on an internal logic relationship thereof. The following implementations of this application are not intended to limit the protection scope of this application.

This application may be applied to a long term evolution (long term evolution, LTE) system, a new radio (new radio, NR) system, or an evolved communication system after 5G (for example, 6G). The communication system includes at least one network device and/or at least one terminal device.

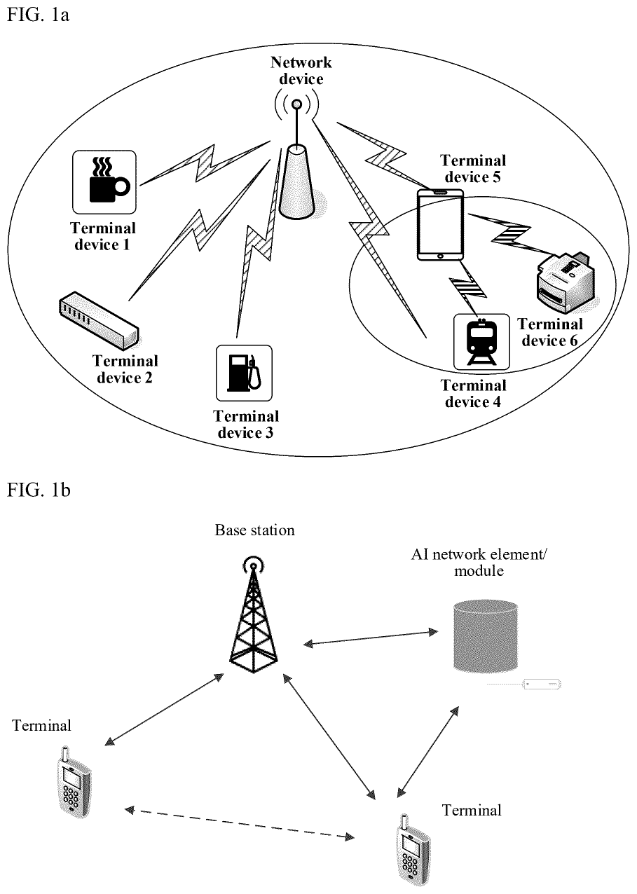

FIG. 1a is a diagram of a communication system according to this application. FIG. 1a shows an example of one network device 101 and six terminal devices. The six terminal devices are a terminal device 1, a terminal device 2, a terminal device 3, a terminal device 4, a terminal device 5, and a terminal device 6. In the example shown in FIG. 1a, an example in which the terminal device 1 is a smart teacup, the terminal device 2 is a smart air conditioner, the terminal device 3 is a smart fuel dispenser, the terminal device 4 is a transport means, the terminal device 5 is a mobile phone, and the terminal device 6 is a printer is used for description.

As shown in FIG. 1a, an AI configuration information sending entity may be the network device. AI configuration information receiving entities may be the terminal device 1 to the terminal device 6. In this case, the network device and the terminal device 1 to the terminal device 6 form a communication system. In the communication system, the terminal device 1 to the terminal device 6 may send data to the network device, and the network device needs to receive the data sent by the terminal device 1 to the terminal device 6. Besides, the network device may send configuration information to the terminal device 1 to the terminal device 6.

Optionally, the AI configuration information may include indication information of a node type mentioned below. The data may include model information of an AI model and/or auxiliary information of the AI model mentioned below.

For example, in FIG. 1a, the terminal device 4 to the terminal device 6 may also form a communication system. The terminal device 5 serves as a network device, that is, an AI configuration information sending entity. The terminal device 4 and the terminal device 6 serve as terminal devices, that is, AI configuration information receiving entities. For example, in an internet of vehicles system, the terminal device 5 separately sends AI configuration information to the terminal device 4 and the terminal device 6, and receives data sent by the terminal device 4 and the terminal device 6; and correspondingly, the terminal device 4 and the terminal device 6 receive the AI configuration information sent by the terminal device 5, and send the data to the terminal device 5.

The communication system shown in FIG. 1a is used as an example. In addition to a communication-related service, an AI-related service may be performed between different devices (including between network devices, between a network device and a terminal device, and/or between terminal devices). For example, as shown in FIG. 1b, an example in which a network device is a base station is used. A communication-related service and an AI-related service may be performed between the base station and one or more terminal devices, and the communication-related service and the AI-related service may also be performed between different terminal devices. Optionally, as shown in FIG. 1b, in addition to the base station and the terminal, an AI network element/module may also participate in performing the AI-related service.

In a current communication system, a 5G core network implements a service-based architecture, and implements decoupling and integration between network functions through modularization. The decoupled network functions are abstracted as network services, and can be independently expanded, independently evolved, and deployed on demand. Interaction between all NFs on a control plane uses a service-based interface. A same type of service may be invoked by a plurality of types of NFs, to reduce a coupling degree defined for an interface between NFs, thereby finally implementing function customization as required in an entire network and flexibly supporting different service scenarios and requirements. To meet the vision of inclusive intelligence in the future, intelligence will further evolve at a wireless network architecture level. In a future communication system, AI may be further integrated deeply with a wireless network, to implement network-inherent intelligence and terminal intelligence. For example, integration of AI and the wireless network may be applied to the following new requirements and new scenarios: For example, terminal connections are more flexible and intelligent, including but not limited to diversified terminal types, a super IoT (an internet of things, an internet of vehicles, industry, medical care, and the like), massive connections, more flexible terminal connections, and terminals having specific AI capabilities. Another example is network-inherent intelligence. In addition to a conventional communication connection service, the network will further provide computing and AI services to better support inclusive, real-time, and highly secure AI services. These new requirements and new scenarios may bring changes to a wireless network architecture and a communication mode.

In addition, in a new wireless network architecture, an AI service capability may further sink to each RAN node (for example, the base station shown in FIG. 1b), that is, the RAN node not only has a communication capability, but also has a computing capability. This integrated communication and computing mode may be referred to as communication-computing convergence. At the beginning of network design, computing power is considered as a basic element of a network. A computing power service, a connection service, and a service that comprehensively considers computing power and a connection are all basic services that a RAN can provide externally. However, a conventional point-to-point interface is still used between RAN nodes and between a RAN node and a core network. In a service-based radio access network (RAN-based Service), it is complex to provide an AI service through collaboration between a plurality of nodes.

In conclusion, in a future communication network, in addition to communication between different communication nodes, artificial intelligence (artificial intelligence, AI) computing power may also need to be considered. Therefore, how to integrate AI computing power with a communication network is an urgent technical problem to be resolved.

To resolve the foregoing problem, this application provides a communication method and a related device, in which a network device provides configuration information of an AI service, so that a terminal device can transmit service information of the AI service based on the configuration information of the AI service, to implement integration of AI computing power and a communication network. The following provides detailed descriptions with reference to the accompanying drawings.

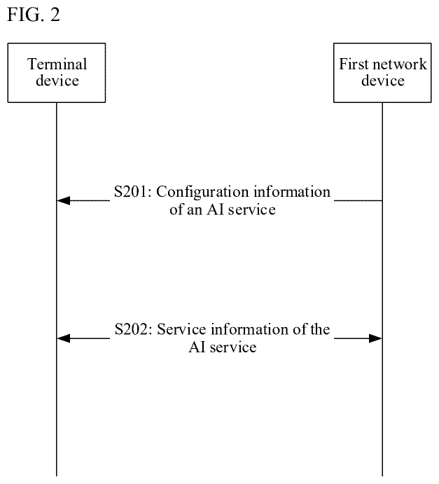

FIG. 2 is a diagram of a communication method according to this application. The method includes the following steps.

It should be noted that in FIG. 2, the method is illustrated by using an example in which a terminal device and a first network device are used as execution bodies of the interaction illustration. However, the execution bodies of the interaction illustration are not limited in this application. For example, in FIG. 2 and a corresponding embodiment, S201 and S202 are performed by the terminal device, or may be performed by a chip, a chip system, or a processor that supports the terminal device in implementing the method, or may be a logical module or software that can implement all or a part of functions of the terminal device. In FIG. 2 and the corresponding embodiment, the first network device in S201 and S202 may alternatively be a chip, a chip system, or a processor that supports the first network device in implementing the method, or may alternatively be a logical module or software that can implement all or a part of functions of the first network device.

S201: The first network device sends configuration information of an AI service, and correspondingly, the terminal device receives the configuration information of the AI service, where the configuration information of the AI service indicates configuration information of a connection function and at least one of the following: an identifier of the AI service, configuration information of a computing function, configuration information of a sensing function, and configuration information of a data function.

It should be noted that the configuration information of the AI service sent by the first network device in step S201 may be used for one or more AI service instances (or referred to as one or more AI services, or referred to as one or more AI tasks, or the like). The AI service instance (or the AI service, the AI task, or the like) may include: a single network device providing an AI training service, a plurality of network devices providing an AI training service, AI split-learning, AI federated learning, or other implementations. This is not limited herein.

Optionally, the configuration information of the connection function indicated by the configuration information of the AI service sent by the first network device in step S201 includes at least one of configuration information of a service data adaptation layer (service data adaptation protocol, SDAP) layer, configuration information of a packet data convergence layer (packet data convergence protocol, PDCP) layer, configuration information of a radio link control (radio link control, RLC) layer, configuration information of a media access control (media access control, MAC) layer, and configuration information of a physical (physical, PHY) layer. Therefore, the terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

Optionally, the configuration information of the computing function indicated by the configuration information of the AI service sent by the first network device in step S201 is for AI model training and/or AI model inference. Therefore, the terminal device can participate in an AI computing process in the AI service scenario based on the configuration information of the AI service.

Optionally, the configuration information of the sensing function indicated by the configuration information of the AI service sent by the first network device in step S201 is for environment parameter measurement and/or environment parameter reporting. Therefore, the terminal device can implement an environment sensing process in the AI service scenario based on the configuration information of the AI service.

Optionally, the configuration information of the data function indicated by the configuration information of the AI service sent by the first network device in step S201 is used to collect data and/or augment data. Therefore, the terminal device can implement an AI data processing process in the AI service scenario based on the configuration information of the AI service.

S202: The terminal device sends service information of the AI service, and correspondingly, the first network device receives the service information of the AI service. Additionally/Alternatively, the first network device sends service information of the AI service, and correspondingly, the terminal device receives the service information of the AI service.

In a possible implementation, the service information of the AI service transmitted between the terminal device and the first network device in step S202 includes at least one of the following: an AI computing result of the first network device, an AI computing result of a terminal device connected to the first network device, an AI computing result of another network device, and an AI computing result of a terminal device connected to the another network device. Specifically, the service information of the AI service received or sent by the first network device may include at least one of the foregoing items, so that the solution is applicable to an application scenario in which a plurality of communication nodes (including at least one communication node of the terminal device, the first network device, and the another network device) provide AI computing power.

In a possible implementation, a part or all of the service information of the AI service transmitted between the terminal device and the first network device in step S202 is carried on a physical downlink shared channel (physical downlink shared channel, PDSCH), and control information associated with the PDSCH indicates the AI service. Specifically, the service information of the AI service transmitted based on the configuration information of the AI service may be carried on the PDSCH, and the control information associated with the PDSCH indicates the AI service, so that the terminal device can identify, based on the control information, information carried on the PDSCH.

Optionally, the control information is downlink control information (downlink control information, DCI) or a media access control control element (media access control control element, MAC CE) transmitted on a physical downlink control channel (physical downlink control channel, PDCCH).

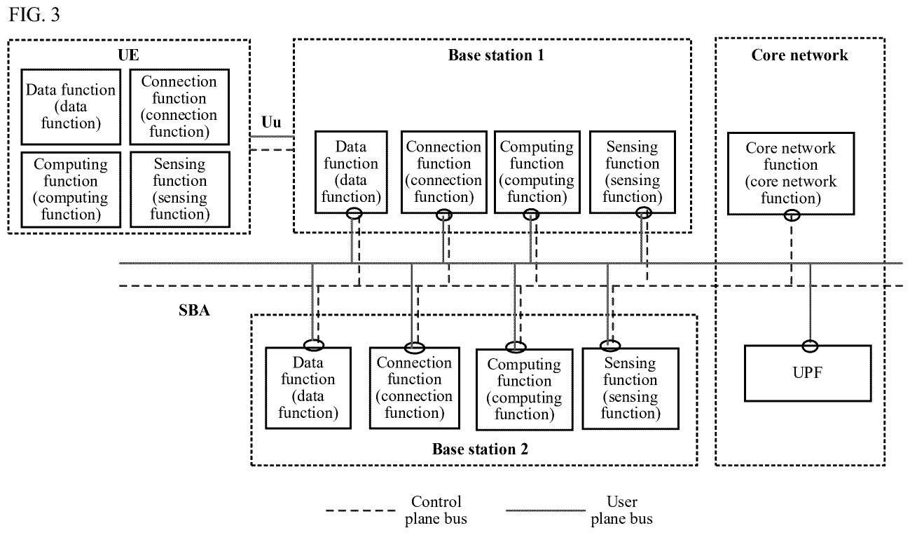

In a possible implementation, corresponding functional modules may be disposed between a network device and a terminal device, and same functional modules of different devices may be connected by using a bus, to implement functions indicated by the configuration information of the AI service. In an implementation example, in FIG. 3, an example in which the terminal device is UE and the first network device is a base station 1 (Base station 1) is used for description. FIG. 3 may further include another access network device (for example, a base station 2 (Base station 2)) and a core network device (Core Network). As shown in FIG. 3, a connection between the terminal device and a network device (for example, between the UE and the base station 1) and a connection between different network devices (for example, between the base station 1 and the base station 2) may be implemented by using a service interface-based bus. Functional modules of each device and related implementation processes may be implemented by using the following Table 1.

TABLE 1

| Functional | | |
|---|---|---|
| module | Service type | Service description |
| Data | Data collection | Includes a data collection |
| function (Data | service (Data | function . . . |
| Function) | collection | |
| | service) | |
| | Data | Includes a data augmentation |
| | augmentation | function . . . |
| | function (Data | |
| | Augmentation | |
| | service) | |
| Computing | Training | Includes a training function . . . |
| function | service (Training | |
| (Computing | service) | |
| Function) | Inference | Includes an inference function . . . |
| | function | |
| | (Inference | |
| | service) | |
| Connection | Service data | Includes QoS mapping . . . |
| function | adaptation layer | |
| (Connection | service (SDAP | |
| Function) | Layer service) | |
| | Packet data | Includes encryption/compression . . . |
| | convergence | |
| | layer service | |
| | (PDCP Layer | |
| | service) | |
| | Radio link | Includes retransmission/segmentation/ |
| | control layer | sorting/reassembly . . . |
| | service (RLC | |
| | Layer service) | |
| | Media access | Includes retransmission/priority |
| | control layer | assignment . . . |
| | service (MAC | |
| | Layer service) | |
| | Physical layer | Includes encoding/modulation/ |
| | service (PHY | waveform . . . |
| | Layer service) | |
| Sensing | Measurement | Includes environment parameter |
| function | and report | measurement/reporting |
| (Sensing | service | |
| Function) | (Measurement & | |
| | Report service) | |

As shown in FIG. 3, the network device may be defined by several function modules, including a connection function (Connection Function) module, a computing function (Computing Function) module, a data function (Data Function) module, a sensing function (Sensing Function) module, and the like. The modules are defined by several service operations, as shown in Table 1.

Optionally, the nodes on the bus may access, by using a service-based interface (for example, an application programming interface (application programming interface, API)), services provided by internal modules of each other.

Optionally, the bus may include a user plane bus and a control plane bus, which are respectively configured to transmit user plane data and control plane data.

Optionally, the bus may be a service-based architecture (service-based architecture, SBA) bus.

Optionally, a core network (core network) element may include a core network function (core network function) module, a user plane function (user plane function, UPF) module, and the like shown in the figure.

In a possible implementation, before the terminal device receives the configuration information of the AI service in step S201, the method further includes: The terminal device sends capability information, where the capability information includes at least one of local data service capability information of the terminal device, local computing service capability information of the terminal device, local sensing service capability information of the terminal device, and local connection service capability information of the terminal device. The terminal device receives a response to the capability information. Specifically, before the terminal device receives the configuration information of the AI service, the terminal device may further send the capability information of the terminal device, so that the network device learns an AI-related capability of the terminal device.

Optionally, the configuration information of the AI service is determined based on the capability information, so that the configuration information provided by the network device can adapt to the capability of the terminal device.

Optionally, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message. The capability information and the response to the capability information can be implemented in any one of the foregoing manners, to improve flexibility of implementing the solution.

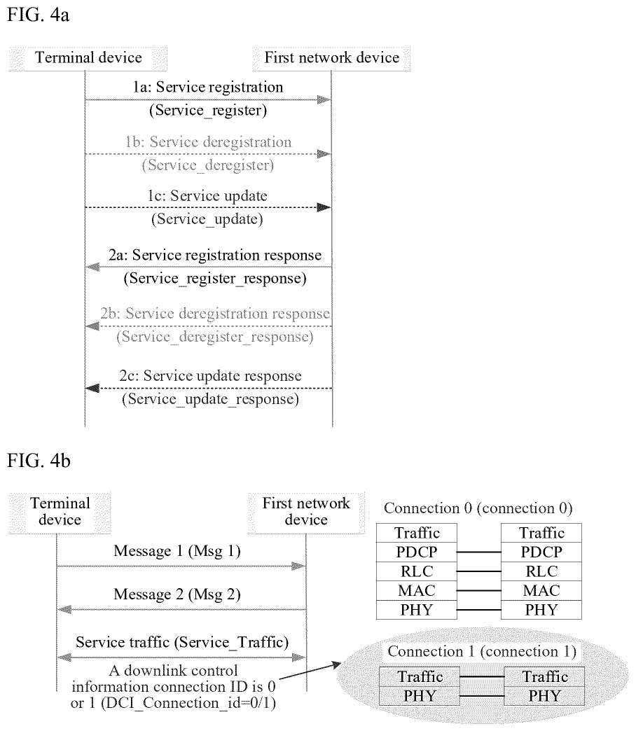

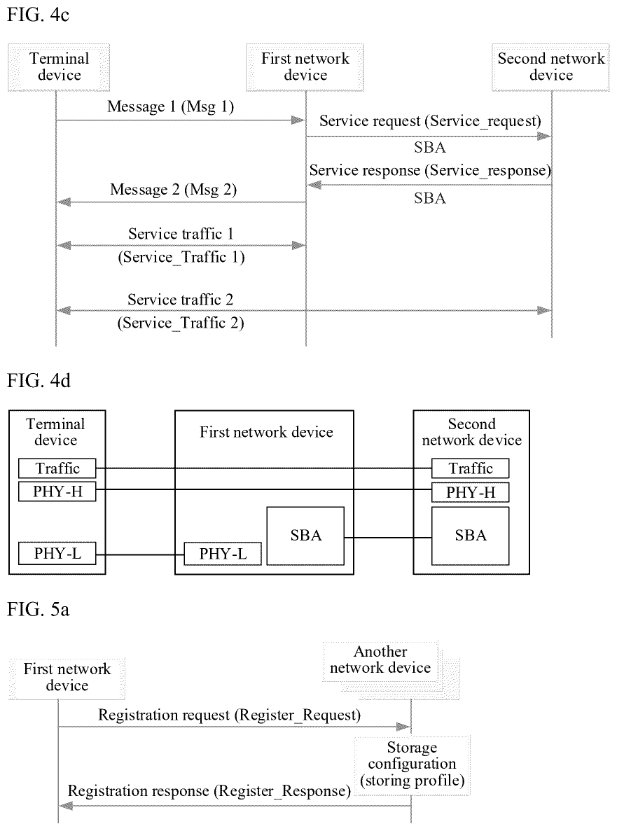

The following uses FIG. 4a as an example for description. As shown in FIG. 4a, a process in which the terminal device reports a capability may include the following process.

The terminal device sends a service registration message (Service_register) in step 1a, and correspondingly, the first network device sends a service registration response message (Service_register_response) in step 2a. Alternatively, the terminal device sends a service deregistration message (Service_deregister) in step 1b, and correspondingly, the first network device sends a service deregistration response message (Service_deregister_response) in step 2b. Alternatively, the terminal device sends a service update message (Service update) in step 1c, and correspondingly, the first network device sends a service update response message (Service update response) in step 2c.

In an implementation example, in step 1a/1b/1c, the terminal device may initiate a service registration procedure, a service deregistration procedure, a service update procedure, and the like to the first network device, to identify: (1) a local data service capability; (2) a local computing service capability; (3) a local sensing service capability; (4) a local connection service capability; and the like.

Optionally, a central node (for example, the first network device) may be defined in a network, to maintain terminal service registration information in a specific region.

In an implementation example, in step 2a/2b/2c, the first network device synchronizes a service parameter of the terminal device in response to the information sent by the terminal device, and exposes a service capability of a terminal in a cell to another node (a RAN, a core network, a third-party node, and the like) in the network through an SBA interface.

Optionally, exposing the service capability to the outside means that the another node in the network may access a corresponding service resource and request a corresponding service capability by using a standardized function.

Optionally, a form of exposing the service capability to the outside may be a mapping table that identifies a capability of each terminal, or may be an equivalent parameter that represents capabilities of all terminals in the cell.

Optionally, in the network, a network device (for example, the first network device) may also expose a service capability of the network device to the outside.

Optionally, an event triggering manner may be used to trigger the terminal device/network device to update a locally mastered service capability (including a network device side and/or a terminal device side) to another node in the network. Further, optionally, event triggering may be triggering at preconfigured cycle time, or may be triggering by a change of a local service capability, or the like.

In a possible implementation, before the terminal device receives the configuration information of the AI service in step S201, the method further includes: The terminal device sends request information used to request the AI service. Specifically, the terminal device may send the request information used to request the AI service, so that the network device sends the configuration information of the AI service based on the request information. Therefore, the foregoing technical solution is applicable to a scenario in which the terminal device requests the AI service.

Optionally, the request information includes at least one of the following: local data resource information of the terminal device, motion status information of the terminal device, the local data service capability information of the terminal device, the local computing service capability information of the terminal device, the local sensing service capability information of the terminal device, the local connection service capability information of the terminal device, service type description information of the AI service, and service target description information of the AI service. Therefore, the network device sends, based on the at least one item, the configuration information of the AI service corresponding to the request information.

The following uses FIG. 4b as an example for description. As shown in FIG. 4b, a process in which the terminal device sends a request message may be implemented by using a process for a message 1 (message 1, Msg 1) in the figure. Correspondingly, step S201 shown in FIG. 2 may be implemented by using a process for a message 2 (message 2, Msg 2) in FIG. 4b, and step S202 shown in FIG. 2 may be implemented by using a process for service traffic (Service_Traffic) in FIG. 4b.

Optionally, the Msg 1 may be denoted as an X resource control (resource control) Msg 1, and the Msg 2 may be denoted as an X resource control (resource control) Msg 2. X may refer to AI, computation (computation), data (data), or the like.

In FIG. 4b, in the process in which the terminal device sends the Msg 1, the Msg 1 may carry a description of a service request. For example, the Msg 1 may include at least one of the following: (1) the local data service capability; (2) the local computing service capability; (3) the local sensing service capability; (4) the local connection service capability; (5) a requested service type description; and (6) a service target description (model accuracy, a convergence delay, and the like).

In FIG. 4b, in response to the request of the terminal device, the first network device adds, to the response message Msg 2, the configuration information of the AI service generated for the terminal device. The configuration information of the AI service may be used for one or more service instances (Service profile). The configuration information of the AI service may indicate at least one of the following: (1) the identifier of the AI service, that is, a service ID; (2) the configuration information of the connection function; (3) the configuration information of the computing function; and (4) the configuration information of the data function.

In an implementation example, each piece of configuration information included in a service instance is shown in Table 2.

TABLE 2

| Service instance | |
|---|---|
| (Service profile) | Parameter description |
| Service ID (Service | Identifier ID of the service |
| ID) | |
| Connection description | Describes configurations of connection |
| (Connection description) | parameters, including a connection ID, a |
| corresponding to the | description of a connection protocol stack |
| configuration information | (including protocol layers and a parameter of |
| of the connection function | each protocol layer), and a description of a |
| | physical resource for connection |
| Computing description | Describes configurations of computing |
| (Computing description) | parameters, including a computing task, a |
| corresponding to the | computing framework (an initial parameter, |
| configuration information | an algorithm description, and the like), a |
| of the computing function | computing requirement (a delay and |
| | accuracy), a location of a computing |
| | resource in the network, a computing |
| | input/output format, and a connection |
| | identifier for transmitting computation |
| | traffic |
| Data description | Describes configurations of data parameters, |
| (Data description) | including a data augmentation description, a |
| corresponding to the | data cleansing description, a data |
| configuration information | distribution description, a data format, a |
| of the data function | location of a data resource in the network, |
| | and a connection identifier for transmitting |
| | data traffic |
| . . . | . . . |

Optionally, the first network device may include a plurality of sets of connection configurations in the response message Msg 2, to respectively carry different types of traffic between the terminal device and the first network device, for example, traffic related to the computing task, traffic related to a sensing task, and traffic related to a data task.

In FIG. 4b, in the process of exchanging Service_Traffic between the terminal device and the first network device, the connection ID may be used for indication. In an implementation example, in FIG. 4b, an example in which the configuration information of the AI service is used for two AI service instances respectively corresponding to two sets of configuration information of the connection function is used. Traffic related to one AI service instance is shown by a connection 0 (connection 0) in FIG. 4b, and includes traffic at a PDCP layer, an RLC layer, a MAC layer, and a PHY layer. Traffic related to the other AI service instance is shown by a connection 1 (connection 1) in FIG. 4b, and includes traffic at the PHY layer. For the terminal device, the terminal device may receive or send the traffic by using the PDSCH, and identify, by using the DCI (or the MAC CE, or the like) associated with the PDSCH, the AI service instances respectively corresponding to the traffic.

It can be learned from the example shown in FIG. 4b that the network device may include several functional modules, and each functional module provides several service operations. In addition, the network device may generate a service instance based on a request of the terminal, and provide related configuration information for the terminal device. Optionally, a connection module provides differentiated pipe services for different AI service implementation processes.

In a possible implementation, before the terminal device receives the configuration information of the AI service in step S201, the method further includes: The first network device receives first information from a second network device, where the first information indicates an AI service capability of the second network device. The first network device determines the configuration information of the AI service based on the first information. Specifically, the first network device may further receive, from the second network device, the first information indicating the AI service capability of the second network device, and the first network device determines the configuration information of the AI service based on the first information. Therefore, the first network device can serve as a decision party for AI computing power of a plurality of network devices to schedule and configure the AI computing power of the plurality of network devices, making the solution applicable to a scenario in which the plurality of network devices participate in AI collaboration.

In a possible implementation, before the terminal device receives the configuration information of the AI service in step S201, the method further includes: The first network device sends second information to a second network device, where the second information indicates an AI service capability of the first network device and/or is used to request the AI service. The first network device receives the configuration information of the AI service. Specifically, the first network device may further send, to the second network device, the second information that indicates the AI service capability of the first network device and/or is used to request the AI service, and the first network device receives the configuration information of the AI service. Therefore, the second network device can serve as a decision party for AI computing power of a plurality of network devices to schedule and configure the AI computing power of the plurality of network devices, making the solution applicable to a scenario in which the plurality of network devices participate in AI collaboration, to provide the AI service across network devices.

Optionally, the AI service capability includes at least one of the following: a data service capability, a computing service capability, a sensing service capability, and a connection service capability, to provide a flexible configuration of the AI service.

The following uses FIG. 4c as an example for description. As shown in FIG. 4c, a process in which the terminal device sends a request message may be implemented by using a process for an Msg 1 in the figure. Correspondingly, step S201 shown in FIG. 2 may be implemented by using a process for a message 2 (message 2, Msg 2) in FIG. 4c, and step S202 shown in FIG. 2 may be implemented by using a process for service traffic 1 (Service_Traffic 1) and a process for service traffic 2 (Service_Traffic 2) in FIG. 4c. In addition, the second information sent by the first network device to the second network device may be a service request (service_request) shown in FIG. 4c, and the configuration information of the AI service sent by the second network device to the first network device may be carried in a service response (service_response) shown in FIG. 4c.

In FIG. 4c, for the process in which the terminal device sends the Msg 1, refer to the implementation process for the Msg 1 in FIG. 4b.

In FIG. 4c, after the first network device receives a request corresponding to the Msg 1, the first network device may send the service request (service_request) to a collaborative node by using the SBA bus, and obtain the service response (service_response).

Optionally, the first network device may negotiate a service profile between nodes by using a control bus of an SBA protocol. The negotiation process is used to determine allocation of a task between the nodes. For example, when determining that a local computing resource is inadequate, the first network device offloads a computing task to the second network device, and configures related computing, connection, and data parameters.

In an implementation example, if the second network device provides the AI service for the terminal device, an air interface connection module of the first network device may be configured to provide a physical (PHY) layer service. Further, the physical layer service may be further classified into a physical high (physical high, PHY-H) layer and a physical low (physical low, PHY-L) layer, and includes operations such as scrambling, quantization, compression, equalization, and symbol mapping. Optionally, as shown in FIG. 4d, the second network device may perform a part of physical (PHY-H) layer processing, for example, quantization. In addition, the second network device forwards encapsulated PHY-H traffic to the first network device by using an SBA protocol stack. The first network device performs remaining physical (PHY-L) layer processing, and transmits encapsulated PHY-H traffic to the terminal device through an air interface.

In FIG. 4c, for the process in which the first network device sends the Msg 2, refer to the implementation process for the Msg 2 in FIG. 4b.

In FIG. 4c, the terminal device exchanges a part or all of the service information of the AI service with the first network device by using Service_Traffic 1, and/or the terminal device exchanges a part or all of the service information of the AI service with the second network device by using Service_Traffic 2.

It can be learned from the example shown in FIG. 4c that a network device can provide the AI service for the terminal device in collaboration with a resource of another network device based on the request of the terminal device by using a service-based interface.

In a possible implementation, in step S202, a process in which the terminal device receives or sends the service information of the AI service based on the configuration information of the AI service may include: The terminal device receives or sends data resource information of the AI service based on the configuration information of the AI service. Specifically, in the process in which the terminal device receives or sends the service information of the AI service based on the configuration information of the AI service, the terminal device may receive the data resource information of the AI service, so that the terminal device locally performs AI computing based on the data resource information of the AI service.

In addition, when the terminal device sends the data resource information of the AI service, the data resource information sent by the terminal device may include local initial data resource information. Therefore, the network device can participate in AI computing based on the initial data resource information. Alternatively, after the network device performs data processing (for example, redundant data deletion or data augmentation) on local initial data of the terminal device, the network device sends processed data to the terminal device, so that the terminal device can perform AI computing based on the processed data.

In a possible implementation, in the method shown in FIG. 2, the method further includes: The first network device sends, to the second network device, indication information indicating the capability information. Specifically, after the first network device receives the capability information from the terminal device, the first network device may further send, to the second network device, the indication information indicating the capability information, so that the another network device can learn an AI-related capability of the terminal device connected to the first network device, to implement AI collaboration across network devices.

In a possible implementation, a part or all of the service information of the AI service transmitted between the terminal device and the first network device in step S202 is service information between the terminal device and the another network device. Specifically, in a scenario in which the first network device connected to the terminal device provides a part or all of the AI service for the terminal device via the another network device, the first network device can serve as a transmission relay between the terminal device and the another network device to receive or send the service information between the terminal device and the another network device.

Optionally, a part or all of the service information of the AI service is service information between the terminal device and the first network device.

According to the foregoing technical solution shown in FIG. 2, in addition to indicating the configuration information of the connection function, the configuration information of the AI service received by the terminal device in step S201 further indicates at least one of the identifier of the AI service, the configuration information of the computing function, the configuration information of the sensing function, and the configuration information of the data function. Therefore, the terminal device receives or sends the service information of the AI service in step S202 based on the configuration information of the connection function and the at least one piece of configuration information. In this way, the network device provides the configuration information of the AI service, so that the terminal device can transmit the service information of the AI service based on the configuration information of the AI service, to implement integration of AI computing power and a communication network.

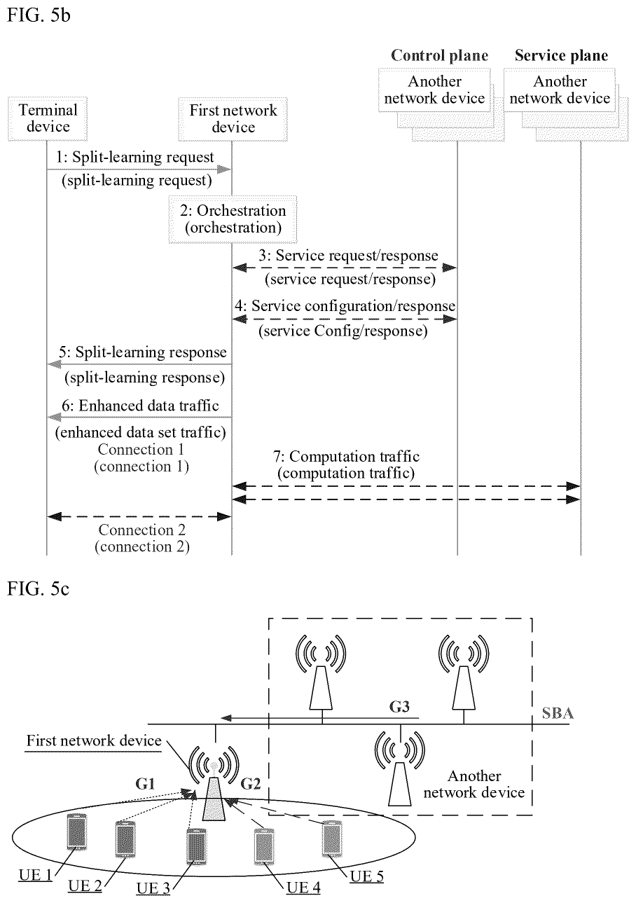

In an implementation example, the method shown in FIG. 2 may be applied to a process of jointly performing split-learning between a terminal device and a network device, and generating a positioning model. The following provides descriptions with reference to processes shown in FIG. 5a and FIG. 5b.

As shown in FIG. 5a, different network devices may learn an AI service capability of another network device in a capability exchange manner. For example, in FIG. 5a, the first network device may send a registration request (Register Request) message to the another network device, where the Register Request message carries a data service capability, a computing service capability, a sensing service capability, a connection service capability, and the like of the first network device. Then, the another network device can store capability information of the first network device in a form of a storage configuration (storing profile), and the another network device sends a registration response (Register_Response) message to the first network device, to indicate, by using the Register_Response message, that the capability information is successfully received.

As shown in FIG. 5b, the terminal device may initiate a split-learning task, including the following steps.

Step 1: The terminal device sends a split-learning request (split-learning request) message, and correspondingly, the first network device receives the split-learning request message. The request message may carry a type of a requested task (for example, fingerprint positioning), a local data resource (for example, a low-level fingerprint positioning data set), and a local computing resource (for example, a graphics processing unit (graphics processing unit, GPU) floating point number, or a central processing unit (central processing unit, CPU) frequency).

Optionally, for the split-learning request message, refer to the foregoing implementation process for the request information used to request the AI service.

The first network device may determine the configuration information of the AI service by using the following step 2, step 3, or step 4.

Step 2: The first network device locally determines a service orchestration (Orchestration). To be specific, the first network device determines, in step 2, network elements participating in the current task and performs the subsequent step 3, and/or determines configuration information of an operation performed by each network element and performs the subsequent step 4.

Step 3: The first network device exchanges a service request/response (Service Request/Response) with the another network device.

Step 4: The first network device exchanges a service configuration/response (Service Config/Response) with the another network device.

Step 5: The first network device sends a split-learning response (split-learning response) message to the terminal device, where the split-learning response message carries the configuration information of the AI service.

It may be understood that a process in which the first network device sends the configuration information of the AI service is an implementation example of step S201. For a specific implementation process, refer to the implementation of step S201, and corresponding technical effects are achieved.

Optionally, the configuration information of the AI service includes configuration information of the connection 1 (connection 1). When the first network device determines that a local data set of the terminal device is inadequate to meet a requirement of the training task, the first network device provides enhanced data traffic (Enhanced Data set traffic) for the terminal in step 6. The first network device establishes the connection 1 for the enhanced data set traffic, where the connection 1 includes complete SDAP-PDCP-RLC-MAC-PHY protocol layers. The first network device sends the encapsulated payload to the terminal device via the physical layer in step 6.

Optionally, the configuration information of the AI service includes configuration information of the connection 2 (connection 2). The first network device determines that the local computing resource is inadequate, and requests a computing service from the another network device in the network. In this embodiment, the another network device provides the computing service for the terminal, and establishes the connection 2 for computation traffic (Computation traffic). After encryption processing, computed data (for example, gradient data) generated by the another network device is transferred to the first network device through an SBA interface or a point-to-point interface. In this case, the connection 2 may include a PHY protocol layer. The first network device performs physical layer operations such as quantization, complex symbol generation, pre-equalization, RE mapping, and waveform generation on the received computed data, and then sends the computed data to the terminal device.

Optionally, the first network device indicates, by using a Connection-ID field in the DCI, that a connection type of the current PDSCH for transmitting traffic is the connection 1 or the connection 2, to facilitate subsequent processing of the terminal device.

It may be understood that step 6 and step 7 are an implementation example of step S202. For a specific implementation process of step 6 and step 7, refer to the implementation of step S202, and corresponding technical effects are achieved.

In another implementation example, the method shown in FIG. 2 may be applied to a process of performing federated learning between a terminal device and a network device. The following provides descriptions with reference to a process shown in FIG. 5c.

Step 1: The first network device starts a federated learning task, and triggers, by using a paging message, a terminal device (including UE 1, UE 2, UE 3, UE 4, UE 5, and the like) in a cell to participate in the task, where the paging message carries a status reporting indication, and the terminal device feeds back status information such as a location and a motion status of the terminal device based on the indication.

Step 2: The first network device classifies the terminal device, for example, a first-type user (including the UE 1, the UE 2, and the UE 3) and a second-type user (including the UE 4 and the UE 5) in FIG. 5c. For example, classification may be based on a motion status of the user, for example, one type is a static user, and the other type is a mobile user.

Optionally, a channel environment in which the static user is located is stable, and over-the-air computation-based fusion is used in subsequent training; and a channel for the mobile user changes, and a conventional fusion manner is used.

Step 3: The first network device separately configures a connection type for the first-type user and the second-type user, where a connection for the first-type user includes the PHY layer (connection 1), and a connection for the second-type user includes the SDAP-PDCP-RLC-MAC-PHY layers (connection 2).

In an implementation example, the first-type user sends gradient data (denoted as G1_UE) to a base station by using the connection 1. After generated by a computation unit of the terminal device, G1_UE is directly sent after a pre-equalization operation. In other words, actually sent data is G1_UE*H⁻¹ (H represents channel information, H⁻¹ represents an inverse of the channel, and “*H⁻¹” represents pre-compensation processing on the channel information). Therefore, the first network device receives gradient data G1 obtained through over-the-air computation-based fusion.

In an implementation example, the second-type user sends gradient data (denoted as G2_UE) to the base station by using the connection 2. After generated by the computation unit of the terminal device, G2_UE is sent to the first network device after conventional operations such as encoding and modulation. After receiving the gradient data of each second-type user, the first network device performs a fusion operation to obtain G2.

Step 4: The base station requests a computing service from another network device in a RAN by using an SBA, and the another network device provides gradient data G3.

Optionally, after abstracting and describing a computing resource of a terminal device in a cell of the another network device, the another network device sends the computing resource in the network by using the SBA, so that the first network device can virtually access, by using the SBA, the computing resource of the terminal device connected to the another network device, and schedule the terminal device to participate in the federated learning task.

Step 5: The first network device completes fusion of G1, G2, and G3 to obtain a fused gradient of an i^{th} round, and sends the fused gradient G to the first-type user and the second-type user (and the virtually accessed terminal device that is managed by the another network device and that participates in the task).

Step 6: Start an (i+1)^{th} round of training, and repeat step 2 to step 5 until the task is complete.

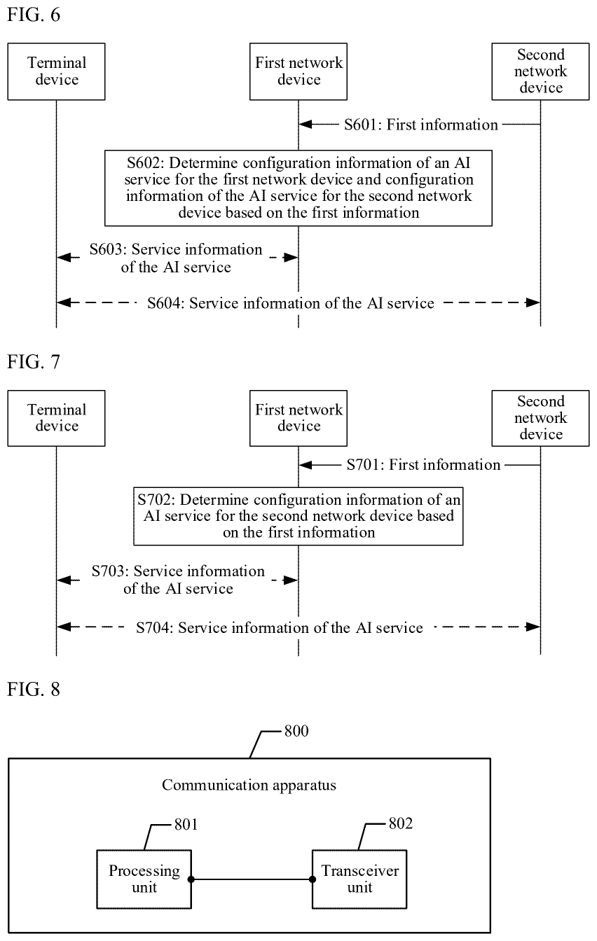

FIG. 6 is a diagram of a communication method according to this application. The method includes the following steps.

S601: A second network device sends first information, and correspondingly, a first network device receives the first information.

S602: The first network device determines configuration information of an AI service for the first network device and configuration information of the AI service for the second network device based on the first information, where the configuration information of the AI service indicates configuration information of a connection function and at least one of the following: an identifier of the AI service, configuration information of a computing function, configuration information of a sensing function, and configuration information of a data function.

In a possible implementation, the configuration information of the connection function determined by the first network device in step S602 includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Therefore, a terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

In a possible implementation, the configuration information of the computing function is for AI model training and/or AI model inference. Therefore, the terminal device can participate in an AI computing process in the AI service scenario based on the configuration information of the AI service.

In a possible implementation, the configuration information of the sensing function is for environment parameter measurement and/or environment parameter reporting.

In a possible implementation, the configuration information of the data function is used to collect data and/or augment data. Therefore, the terminal device can implement an environment sensing process in the AI service scenario based on the configuration information of the AI service.

In a possible implementation, an AI service capability includes at least one of the following: a data service capability, a computing service capability, a sensing service capability, and a connection service capability. Therefore, the terminal device can implement an AI data processing process in the AI service scenario based on the configuration information of the AI service.

Based on the technical solution shown in FIG. 6, after the first network device receives, in step S601 from the second network device, the first information indicating the AI service capability of the second network device, the first network device determines in step S602 the configuration information of the AI service for the first network device and the configuration information of the AI service for the second network device based on the first information. In addition to indicating the configuration information of the connection function, the configuration information of the AI service further indicates at least one of the identifier of the AI service, the configuration information of the computing function, the configuration information of the sensing function, and the configuration information of the data function. Therefore, the first network device receives or sends service information of the AI service based on the configuration information of the connection function and the at least one piece of configuration information. In this way, capabilities are exchanged between different network devices to provide the configuration information of the AI service, so that the first network device can subsequently transmit the service information of the AI service based on the configuration information of the AI service, to implement integration of AI computing power and a communication network.

In addition, the first network device can serve as a decision party for AI computing power of a plurality of network devices to schedule and configure the AI computing power of the plurality of network devices, making the solution applicable to a scenario in which the plurality of network devices participate in AI collaboration.

In a possible implementation, in the method shown in FIG. 6, the method further includes: The first network device sends the configuration information of the AI service for the second network device. The second network device receives the configuration information of the AI service for the second network device. Specifically, the second network device may further receive the configuration information of the AI service for the second network device from the first network device, so that the first network device can serve as the decision party for the AI computing power of the plurality of network devices to schedule and configure the AI computing power of the plurality of network devices.

In a possible implementation, in the method shown in FIG. 6, the method further includes: The second network device sends third information, where the third information indicates that the configuration information of the AI service for the second network device is confirmed. The first network device receives the third information. Specifically, the first network device may further receive the third information indicating that the configuration information of the AI service for the second network device is confirmed, so that the first network device determines, based on the third information, that the second network device has successfully received the configuration information of the AI service for the second network device, and subsequently, a terminal device connected to the first network device can obtain the AI service provided by the first network device and the second network device.

In a possible implementation, in the method shown in FIG. 6, the method further includes the following step.

Step S603: The terminal device sends the service information of the AI service, and correspondingly, the first network device receives the service information of the AI service. Alternatively, the first network device sends the service information of the AI service, and correspondingly, the terminal device receives the service information of the AI service.

In step S603, in a process in which the first network device provides the AI service for the terminal device connected to the first network device, the service information of the AI service may be received or sent between the first network device and the terminal device based on the configuration information of the AI service for the first network device.

In a possible implementation, in the method shown in FIG. 6, the method further includes the following step.

Step S604: The terminal device sends the service information of the AI service, and correspondingly, the second network device receives the service information of the AI service. Alternatively, the second network device sends the service information of the AI service, and correspondingly, the terminal device receives the service information of the AI service.

In step S604, in a process in which the second network device provides the AI service for the terminal device connected to the first network device, the first network device can serve as a transmission relay to receive or send the service information of the AI service between the second network device and the terminal device based on the configuration information of the AI service for the second network device.

In a possible implementation, the service information of the AI service in step S603 and/or step S604 includes at least one of the following: an AI computing result of the first network device, an AI computing result of the terminal device connected to the first network device, an AI computing result of another network device, and an AI computing result of a terminal device connected to the another network device. Specifically, the service information of the AI service received or sent by the terminal device may include at least one of the foregoing items, so that the solution is applicable to an application scenario in which a plurality of communication nodes (including at least one communication node of the terminal device, the first network device, and the another network device) provide AI computing power.

FIG. 7 is a diagram of a communication method according to this application. The method includes the following steps.

S701: A second network device sends first information, and correspondingly, a first network device receives the first information.

S702: The first network device determines configuration information of an AI service for the second network device based on the first information, where the configuration information of the AI service indicates configuration information of a connection function and at least one of the following: an identifier of the AI service, configuration information of a computing function, configuration information of a sensing function, and configuration information of a data function.

In a possible implementation, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Therefore, a terminal device can flexibly configure a communication connection function in an AI service scenario based on the configuration information of the AI service without being limited to a conventional communication connection configuration (to be specific, the conventional communication connection configuration includes configurations of protocol layers of SDAP, PDCP, RLC, MAC, and PHY).

In a possible implementation, the configuration information of the computing function is for AI model training and/or AI model inference. Therefore, the terminal device can participate in an AI computing process in the AI service scenario based on the configuration information of the AI service.

In a possible implementation, the configuration information of the sensing function is for environment parameter measurement and/or environment parameter reporting.

In a possible implementation, the configuration information of the data function is used to collect data and/or augment data. Therefore, the terminal device can implement an environment sensing process in the AI service scenario based on the configuration information of the AI service.

In a possible implementation, an AI service capability includes at least one of the following: a data service capability, a computing service capability, a sensing service capability, and a connection service capability. Therefore, the terminal device can implement an AI data processing process in the AI service scenario based on the configuration information of the AI service.

Based on the technical solution in FIG. 7, after the first network device receives, in step S701 from the second network device, the first information indicating the AI service capability of the second network device, the first network device determines in step S702 the configuration information of the AI service for the second network device based on the first information. In addition to indicating the configuration information of the connection function, the configuration information of the AI service further indicates at least one of the identifier of the AI service, the configuration information of the computing function, the configuration information of the sensing function, and the configuration information of the data function. Therefore, the first network device receives or sends service information of the AI service based on the configuration information of the connection function and the at least one piece of configuration information. In this way, capabilities are exchanged between different network devices to provide the configuration information of the AI service, so that the second network device can subsequently transmit the service information of the AI service based on the configuration information of the AI service, to implement integration of AI computing power and a communication network.

In addition, the first network device can serve as a decision party for AI computing power of a plurality of network devices to schedule and configure AI computing power of another network device (for example, the second network device).

In a possible implementation, in the method shown in FIG. 7, the method further includes: The first network device sends the configuration information of the AI service for the second network device. The second network device receives the configuration information of the AI service for the second network device. Specifically, the second network device may further receive the configuration information of the AI service for the second network device from the first network device, so that the first network device can serve as the decision party for the AI computing power of the plurality of network devices to schedule and configure the AI computing power of the another network device (for example, the second network device).

In a possible implementation, in the method shown in FIG. 7, the method further includes: The second network device sends third information, where the third information indicates that the configuration information of the AI service for the second network device is confirmed. The first network device receives the third information. Specifically, the first network device may further receive the third information indicating that the configuration information of the AI service for the second network device is confirmed, so that the first network device determines, based on the third information, that the second network device has successfully received the configuration information of the AI service for the second network device, and subsequently, a terminal device connected to the first network device can obtain the AI service provided by the second network device.

In a possible implementation, in the method shown in FIG. 7, the method further includes the following step.

Step S703: The terminal device sends the service information of the AI service, and correspondingly, the first network device receives the service information of the AI service. Alternatively, the first network device sends the service information of the AI service, and correspondingly, the terminal device receives the service information of the AI service.

Specifically, the first network device determines configuration information of the AI service for the first network device based on the first information. In step S703, the first network device sends the service information of the AI service to the terminal device via the second network device or receives the service information of the AI service from the terminal device via the second network device based on the configuration information of the AI service for the first network device. In this way, the first network device may further determine the configuration information of the AI service for the first network device based on the first information, so that the first network device can serve as the decision party for the AI computing power of the plurality of network devices to schedule and configure the AI computing power of the plurality of network devices, making the solution applicable to a scenario in which the plurality of network devices participate in AI collaboration.

In addition, in a process in which the first network device provides the AI service for a terminal device connected to the second network device, the second network device can serve as a transmission relay to receive or send the service information of the AI service between the first network device and the terminal device based on the configuration information of the AI service for the first network device.

In a possible implementation, in the method shown in FIG. 7, the method further includes the following step.

Step S704: The terminal device sends the service information of the AI service, and correspondingly, the second network device receives the service information of the AI service. Alternatively, the second network device sends the service information of the AI service, and correspondingly, the terminal device receives the service information of the AI service.

In step S704, in a process in which the second network device provides the AI service for the terminal device connected to the first network device, the first network device can serve as a transmission relay to receive or send the service information of the AI service between the second network device and the terminal device based on the configuration information of the AI service for the second network device.

In a possible implementation, the method further includes: The first network device receives fourth information from a third network device, where the fourth information indicates an AI service capability of the third network device. That the first network device determines the configuration information of the AI service for the second network device based on the first information includes: The first network device determines the configuration information of the AI service for the second network device and configuration information of the AI service for the third network device based on the first information and the fourth information. The first network device sends the configuration information of the AI service for the third network device to the third network device. The third network device sends the service information of the AI service to the terminal device via the second network device or receives the service information of the AI service from the terminal device via the second network device based on the configuration information of the AI service for the third network device.

According to the foregoing technical solution, the first network device may further determine the configuration information of the AI service for the first network device based on the first information, so that the first network device can serve as the decision party for the AI computing power of the plurality of network devices to schedule and configure the AI computing power of the plurality of network devices, making the solution applicable to the scenario in which the plurality of network devices participate in AI collaboration.

In addition, in a process in which the third network device provides the AI service for a terminal device connected to the second network device, the second network device can serve as a transmission relay to receive or send the service information of the AI service between the third network device and the terminal device based on the configuration information of the AI service for the third network device.

In a possible implementation, the service information of the AI service includes at least one of the following: an AI computing result of the first network device, an AI computing result of the terminal device connected to the first network device, an AI computing result of the another network device, and an AI computing result of a terminal device connected to the another network device. In this way, the service information of the AI service received or sent by the terminal device may include at least one of the foregoing items, so that the solution is applicable to an application scenario in which a plurality of communication nodes (including at least one communication node of the terminal device, the first network device, and the another network device) provide AI computing power.

Refer to FIG. 8. An embodiment of this application provides a communication apparatus 800. The communication apparatus 800 can implement a function of the terminal device (or the network device) in the foregoing method embodiments, and therefore can also achieve beneficial effects of the foregoing method embodiments. In this embodiment of this application, the communication apparatus 800 may be the terminal device (or the network device), or may be an integrated circuit, an element, or the like inside the terminal device (or the network device), for example, a chip. In the following embodiments, an example in which the communication apparatus 800 is the terminal device (or the network device) is used for description.

In a possible implementation, when the apparatus 800 is configured to perform the method performed by the terminal device in any one of the foregoing embodiments, the apparatus 800 includes a processing unit 801 and a transceiver unit 802. The transceiver unit 802 is configured to receive configuration information of an artificial intelligence AI service, where the configuration information of the AI service indicates configuration information of a connection function and at least one of the following: an identifier of the AI service, configuration information of a computing function, configuration information of a sensing function, and configuration information of a data function. The processing unit 801 is configured to receive or send, via the transceiver unit 802, service information of the AI service based on the configuration information of the AI service.

In a possible implementation, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, and configuration information of a physical PHY layer. Alternatively, the configuration information of the computing function is for AI model training and/or AI model inference. Alternatively, the configuration information of the sensing function is for environment parameter measurement and/or environment parameter reporting. Alternatively, the configuration information of the data function is used to collect data and/or augment data.

In a possible implementation, a part or all of the service information of the AI service is carried on a physical downlink shared channel PDSCH, and control information associated with the PDSCH indicates the AI service.

In a possible implementation, the control information is downlink control information DCI or a media access control control element MAC CE transmitted on a physical downlink control channel PDCCH.

In a possible implementation, the transceiver unit 802 is further configured to send request information used to request the AI service.

In a possible implementation, the request information includes at least one of the following: local data resource information of the terminal device, motion status information of the terminal device, local data service capability information of the terminal device, local computing service capability information of the terminal device, local sensing service capability information of the terminal device, local connection service capability information of the terminal device, service type description information of the AI service, and service target description information of the AI service.

In a possible implementation, the processing unit 801 is specifically configured to receive or send, via the transceiver unit 802, data resource information of the AI service based on the configuration information of the AI service.

In a possible implementation, the transceiver unit 802 is further configured to send capability information, where the capability information includes at least one of the local data service capability information of the terminal device, the local computing service capability information of the terminal device, the local sensing service capability information of the terminal device, and the local connection service capability information of the terminal device. The transceiver unit 802 is further configured to receive a response to the capability information.

In a possible implementation, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

In a possible implementation, when the apparatus 800 is configured to perform the method performed by the first network device in any one of the foregoing embodiments, the apparatus 800 includes a processing unit 801 and a transceiver unit 802. The transceiver unit 802 is configured to send configuration information of an artificial intelligence AI service, where the configuration information of the AI service indicates configuration information of a connection function and at least one of the following: an identifier of the AI service, configuration information of a computing function, configuration information of a sensing function, or configuration information of a data function. The processing unit 801 is configured to receive or send, via the transceiver unit 802, service information of the AI service based on the configuration information of the AI service.

In a possible implementation, the configuration information of the connection function includes at least one of configuration information of a service data adaptation layer SDAP layer, configuration information of a packet data convergence layer PDCP layer, configuration information of a radio link control RLC layer, configuration information of a media access control MAC layer, or configuration information of a physical PHY layer. Alternatively, the configuration information of the computing function is for AI model training and/or AI model inference. Alternatively, the configuration information of the sensing function is for environment parameter measurement and/or environment parameter reporting. Alternatively, the configuration information of the data function is used to collect data and/or augment data.

In a possible implementation, a part or all of the service information of the AI service is carried on a physical downlink shared channel PDSCH, and control information associated with the PDSCH indicates the AI service.

In a possible implementation, the control information is downlink control information DCI or a media access control control element MAC CE transmitted on a physical downlink control channel PDCCH.

In a possible implementation, the transceiver unit 802 is further configured to receive request information used to request the AI service.

In a possible implementation, the request information includes at least one of the following: local data resource information of a terminal device, motion status information of the terminal device, local data service capability information of the terminal device, local computing service capability information of the terminal device, local sensing service capability information of the terminal device, local connection service capability information of the terminal device, service type description information of the AI service, or service target description information of the AI service.

In a possible implementation, the processing unit 801 is specifically configured to receive or send, via the transceiver unit 802, data resource information of the AI service based on the configuration information of the AI service.

In a possible implementation, the transceiver unit 802 is further configured to receive capability information, where the capability information includes at least one of the local data service capability information of the terminal device, the local computing service capability information of the terminal device, the local sensing service capability information of the terminal device, or the local connection service capability information of the terminal device. The transceiver unit 802 is further configured to send a response to the capability information.

In a possible implementation, the capability information is carried in a service registration message, and the response to the capability information is carried in a service registration response message. Alternatively, the capability information is carried in a service deregistration message, and the response to the capability information is carried in a service deregistration response message. Alternatively, the capability information is carried in a service update message, and the response to the capability information is carried in a service update response message.

In a possible implementation, the transceiver unit 802 is further configured to send, to a second network device, indication information indicating the capability information.

In a possible implementation, the transceiver unit 802 is further configured to receive first information from the second network device, where the first information indicates an AI service capability of the second network device. The processing unit 801 is further configured to determine the configuration information of the AI service based on the first information.

In a possible implementation, the transceiver unit 802 is further configured to send second information to the second network device, where the second information indicates an AI service capability of the first network device and/or is used to request the AI service. The transceiver unit 802 is further configured to receive the configuration information of the AI service.

In a possible implementation, the AI service capability includes at least one of the following: a data service capability, a computing service capability, a sensing service capability, and a connection service capability.

In a possible implementation, a part or all of the service information of the AI service is service information between the terminal device and another network device.

In a possible implementation, the service information of the AI service includes at least one of the following: an AI computing result of the first network device, an AI computing result of a terminal device connected to the first network device, an AI computing result of the another network device, and an AI computing result of a terminal device connected to the another network device.

It should be noted that for details of content such as an information execution process of the unit of the communication apparatus 800, refer to the descriptions in the foregoing method embodiments of this application. Details are not described herein again.

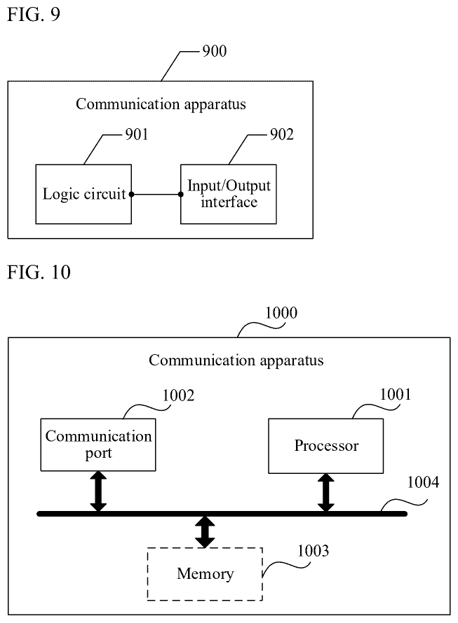

FIG. 9 is another diagram of a structure of a communication apparatus 900 according to this application. The communication apparatus 900 includes at least an input/output interface 902. The communication apparatus 900 may be a chip or an integrated circuit.

Optionally, the communication apparatus further includes a logic circuit 901.

The transceiver unit 802 shown in FIG. 8 may be a communication interface. The communication interface may be the input/output interface 902 in FIG. 9, and the input/output interface 902 may include an input interface and an output interface. Alternatively, the communication interface may be a transceiver circuit, and the transceiver circuit may include an input interface circuit and an output interface circuit.

Optionally, the input/output interface 902 is configured to receive configuration information of an artificial intelligence AI service, where the configuration information of the AI service indicates configuration information of a connection function and at least one of the following: an identifier of the AI service, configuration information of a computing function, configuration information of a sensing function, and configuration information of a data function. The logic circuit 901 is configured to receive or send, via the input/output interface 902, service information of the AI service based on the configuration information of the AI service.

The logic circuit 901 and the input/output interface 902 may further perform other steps performed by a terminal device in any embodiment, and achieve corresponding beneficial effects. Details are not described herein again.

Optionally, the input/output interface 902 is configured to send configuration information of an artificial intelligence AI service, where the configuration information of the AI service indicates configuration information of a connection function and at least one of the following: an identifier of the AI service, configuration information of a computing function, configuration information of a sensing function, or configuration information of a data function. The logic circuit 901 is configured to receive or send, via the input/output interface 902, service information of the AI service based on the configuration information of the AI service.

The logic circuit 901 and the input/output interface 902 may further perform other steps performed by a network device (for example, a first network device or a second network device) in any embodiment, and achieve corresponding beneficial effects. Details are not described herein again.

In a possible implementation, the processing unit 801 shown in FIG. 8 may be the logic circuit 901 in FIG. 9.

Optionally, the logic circuit 901 may be a processing apparatus. A part or all of functions of the processing apparatus may be implemented by using software.

Optionally, the processing apparatus may include a memory and a processor. The memory is configured to store a computer program. The processor reads and executes the computer program stored in the memory, to perform corresponding processing and/or steps in any method embodiment.

Optionally, the processing apparatus may include only a processor. A memory configured to store a computer program is located outside the processing apparatus. The processor is connected to the memory through a circuit/wire, to read and execute the computer program stored in the memory. The memory and the processor may be integrated together, or may be physically independent of each other.

Optionally, the processing apparatus may be one or more chips or one or more integrated circuits. For example, the processing apparatus may be one or more field-programmable gate arrays (field-programmable gate array, FPGA), application-specific integrated circuits (application-specific integrated circuit, ASIC), systems on chip (system on chip, SoC), central processing units (central processing unit, CPU), network processors (network processor, NP), digital signal processors (digital signal processor, DSP), microcontroller units (microcontroller unit, MCU), programmable logic devices (programmable logic device, PLD), or other integrated chips, or any combination of the foregoing chips or processors.

FIG. 10 shows a communication apparatus 1000 in the foregoing embodiment according to an embodiment of this application. The communication apparatus 1000 may be specifically the communication apparatus used as the terminal device in the foregoing embodiment. In the example shown in FIG. 10, the communication is implemented by using a terminal device (or a component in a terminal device).

In a possible diagram of a logical structure of the communication apparatus 1000, the communication apparatus 1000 may include but is not limited to at least one processor 1001 and a communication port 1002.

Further, optionally, the apparatus may further include at least one of a memory 1003 and a bus 1004. In this embodiment of this application, the at least one processor 1001 is configured to control an action of the communication apparatus 1000.

In addition, the processor 1001 may be a central processing unit, a general-purpose processor, a digital signal processor, an application-specific integrated circuit, a field-programmable gate array or another programmable logic device, a transistor logic device, a hardware component, or any combination thereof. The processor may implement or execute various example logical blocks, modules, and circuits described with reference to content disclosed in this application. Alternatively, the processor may be a combination implementing a computing function, for example, a combination of one or more microprocessors, or a combination of a digital signal processor and a microprocessor. It may be clearly understood by a person skilled in the art that, for the purpose of convenient and brief description, for a detailed working process of the foregoing system, apparatus, and unit, refer to a corresponding process in the foregoing method embodiments, and details are not described herein again.

It should be noted that the communication apparatus 1000 shown in FIG. 10 may be specifically configured to implement steps implemented by the terminal device in the foregoing method embodiments, and achieve technical effects corresponding to the terminal device. For a specific implementation of the communication apparatus shown in FIG. 10, refer to the descriptions in the foregoing method embodiments. Details are not described herein again.

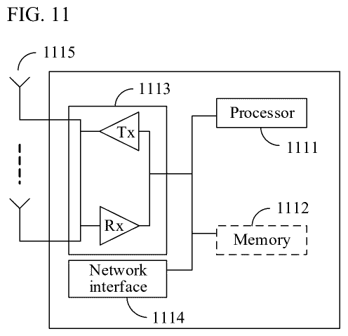

FIG. 11 is a diagram of a structure of a communication apparatus 1100 in the foregoing embodiment according to an embodiment of this application. The communication apparatus 1100 may be specifically the communication apparatus used as the network device (for example, the first network device or the second network device) in the foregoing embodiment. For a structure of the communication apparatus, refer to the structure shown in FIG. 11.

The communication apparatus 1100 includes at least one processor 1111 and at least one network interface 1114. Further, optionally, the communication apparatus further includes at least one memory 1112, at least one transceiver 1113, and one or more antennas 1115. The processor 1111, the memory 1112, the transceiver 1113, and the network interface 1114 are connected, for example, connected through a bus. In this embodiment of this application, the connection may include various types of interfaces, transmission lines, buses, or the like. This is not limited in this embodiment. The antenna 1115 is connected to the transceiver 1113. The network interface 1114 is configured to enable the communication apparatus to communicate with another communication device through a communication link. For example, the network interface 1114 may include a network interface between the communication apparatus and a core network device, for example, an S1 interface. The network interface may include a network interface between the communication apparatus and another communication apparatus (for example, another network device or core network device), for example, an X2 or Xn interface.

The processor 1111 is mainly configured to: process a communication protocol and communication data, control the entire communication apparatus, execute a software program, and process data of the software program, for example, is configured to support the communication apparatus in performing actions described in embodiments. The communication apparatus may include a baseband processor and a central processing unit. The baseband processor is mainly configured to process the communication protocol and the communication data. The central processing unit is mainly configured to: control an entire terminal device, execute the software program, and process the data of the software program. The processor 1111 in FIG. 11 may integrate functions of the baseband processor and the central processing unit. A person skilled in the art may understand that the baseband processor and the central processing unit may be processors independent of each other, and are interconnected by using a technology, for example, a bus. A person skilled in the art may understand that the terminal device may include a plurality of baseband processors to adapt to different network standards, the terminal device may include a plurality of central processing units to enhance processing capabilities of the terminal device, and components of the terminal device may be connected by using various buses. The baseband processor may also be expressed as a baseband processing circuit or a baseband processing chip. The central processing unit may also be expressed as a central processing circuit or a central processing chip. A function of processing the communication protocol and the communication data may be built in the processor, or may be stored in the memory in a form of a software program, and the processor executes the software program to implement a baseband processing function.

The memory is mainly configured to store the software program and data. The memory 1112 may exist independently, and is connected to the processor 1111. Optionally, the memory 1112 may be integrated with the processor 1111, for example, integrated into a chip. The memory 1112 can store program code for executing the technical solutions in embodiments of this application, and the processor 1111 controls the execution. Various types of executed computer program code may also be considered as a driver of the processor 1111.

FIG. 11 shows only one memory and one processor. In an actual terminal device, there may be a plurality of processors and a plurality of memories. The memory may also be referred to as a storage medium, a storage device, or the like. The memory may be a storage element on a same chip as the processor, that is, an on-chip storage element, or may be an independent storage element. This is not limited in this embodiment of this application.

The transceiver 1113 may be configured to support receiving or sending of a radio frequency signal between the communication apparatus and a terminal. The transceiver 1113 may be connected to the antenna 1115. The transceiver 1113 includes a transmitter Tx and a receiver Rx. Specifically, the one or more antennas 1115 may receive a radio frequency signal. The receiver Rx of the transceiver 1113 is configured to: receive the radio frequency signal from the antenna, convert the radio frequency signal into a digital baseband signal or a digital intermediate frequency signal, and provide the digital baseband signal or the digital intermediate frequency signal to the processor 1111, so that the processor 1111 performs further processing, for example, demodulation and decoding, on the digital baseband signal or the digital intermediate frequency signal. In addition, the transmitter Tx of the transceiver 1113 is further configured to: receive a modulated digital baseband signal or digital intermediate frequency signal from the processor 1111, convert the modulated digital baseband signal or digital intermediate frequency signal into a radio frequency signal, and send the radio frequency signal through the one or more antennas 1115. Specifically, the receiver Rx may selectively perform one-level or multi-level down mixing processing and analog-to-digital conversion processing on the radio frequency signal, to obtain the digital baseband signal or the digital intermediate frequency signal. A sequence of the down mixing processing and the analog-to-digital conversion processing may be adjusted. The transmitter Tx may selectively perform one-level or multi-level up mixing processing and digital-to-analog conversion processing on the modulated digital baseband signal or digital intermediate frequency signal, to obtain the radio frequency signal. A sequence of the up mixing processing and the digital-to-analog conversion processing may be adjusted. The digital baseband signal and the digital intermediate frequency signal may be collectively referred to as a digital signal.

The transceiver 1113 may also be referred to as a transceiver unit, a transceiver machine, a transceiver apparatus, or the like. Optionally, a device that is in the transceiver unit and that is configured to implement a receiving function may be considered as a receiving unit, and a device that is in the transceiver unit and that is configured to implement a sending function may be considered as a sending unit. In other words, the transceiver unit includes the receiving unit and the sending unit. The receiving unit may also be referred to as a receiver machine, an input port, a receiver circuit, or the like. The sending unit may be referred to as a transmitter machine, a transmitter, a transmitter circuit, or the like.

It should be noted that the communication apparatus 1100 shown in FIG. 11 may be specifically configured to implement steps implemented by the network device (for example, the first network device or the second network device) in the foregoing method embodiments, and achieve technical effects corresponding to the network device. For a specific implementation of the communication apparatus 1100 shown in FIG. 11, refer to the descriptions in the foregoing method embodiments. Details are not described herein again.

An embodiment of this application further provides a computer-readable storage medium storing one or more computer-executable instructions. When the computer-executable instructions are executed by a processor, the processor performs the method in the possible implementations of the terminal device in the foregoing embodiments.

An embodiment of this application further provides a computer-readable storage medium storing one or more computer-executable instructions. When the computer-executable instructions are executed by a processor, the processor performs the method in the possible implementations of the network device (for example, the first network device or the second network device) in the foregoing embodiments.

An embodiment of this application further provides a computer program product (or referred to as a computer program) storing one or more computer-executable instruction s. When the computer program product is executed by a processor, the processor performs the method in the possible implementations of the terminal device.

An embodiment of this application further provides a computer program product storing one or more computer-executable instructions. When the computer program product is executed by a processor, the processor performs the method in the possible implementations of the network device (for example, the first network device or the second network device).

An embodiment of this application further provides a chip system. The chip system includes at least one processor, configured to support a communication apparatus in implementing a function in the possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete component. The communication apparatus may be specifically the terminal device in the foregoing method embodiments.

An embodiment of this application further provides a chip system. The chip system includes at least one processor, configured to support a communication apparatus in implementing a function in the possible implementations of the communication apparatus. Optionally, the chip system further includes an interface circuit, and the interface circuit provides program instructions and/or data for the at least one processor. In a possible design, the chip system may further include a memory. The memory is configured to store program instructions and data that are necessary for the communication apparatus. The chip system may include a chip, or may include a chip and another discrete device. The communication apparatus may be specifically the network device (for example, the first network device or the second network device) in the foregoing method embodiments.

An embodiment of this application further provides a communication system. The communication system includes at least two of the terminal device, the first network device, and the second network device in any one of the foregoing embodiments.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Apart or all of the units may be selected based on actual requirements to achieve the objectives of the solutions of embodiments.

In addition, functional units in embodiments of this application may be integrated into one processing unit, or each of the units may exist alone physically, or two or more units may be integrated into one unit. The integrated unit may be implemented in a form of hardware, or may be implemented in a form of a software functional unit. When the integrated unit is implemented in the form of the software functional unit and sold or used as an independent product, the integrated unit may be stored in a computer-readable storage medium. Based on such an understanding, the technical solutions of this application essentially, or the part contributing to the conventional technology, or all or a part of the technical solutions may be implemented in the form of a software product. The computer software product is stored in a storage medium and includes several instructions for instructing a computer device (which may be a personal computer, a server, or a network device) to perform all or a part of the steps of the methods described in embodiments of this application. The storage medium includes any medium that can store program code, such as a USB flash drive, a removable hard disk drive, a read-only memory (ROM, Read-Only Memory), a random access memory (RAM, Random Access Memory), a magnetic disk, or an optical disc.

What is claimed is:

1. A communication method, comprising:
receiving configuration information of an artificial intelligence (AI) service, wherein the configuration information of the AI service indicates configuration information of a connection function and at least one of the following: an identifier of the AI service, configuration information of a computing function, configuration information of a sensing function, and configuration information of a data function; and
receiving or sending service information of the AI service based on the configuration information of the AI service.

2. The method according to claim 1, wherein
the configuration information of the connection function comprises at least one of configuration information of a service data adaptation protocol (SDAP) layer, configuration information of a packet data convergence protocol (PDCP) layer, configuration information of a radio link control (RLC) layer, configuration information of a media access control (MAC) layer, and configuration information of a physical (PHY) layer; or
the configuration information of the computing function is for AI model training and/or AI model inference; or
the configuration information of the sensing function is for environment parameter measurement and/or environment parameter reporting; or
the configuration information of the data function is used to collect data and/or augment data.

3. The method according to claim 1, wherein a part or all of the service information of the AI service is carried on a physical downlink shared channel (PDSCH), and control information associated with the PDSCH indicates the AI service.

4. The method according to claim 3, wherein the control information is downlink control information (DCI) or a media access control control element (MAC CE) transmitted on a physical downlink control channel (PDCCH).

5. The method according to claim 1, wherein before receiving the configuration information of the AI service, the method further comprises:
sending request information used to request the AI service.

6. The method according to claim 5, wherein the request information comprises at least one of the following:
local data resource information of a terminal device, motion status information of the terminal device, local data service capability information of the terminal device, local computing service capability information of the terminal device, local sensing service capability information of the terminal device, local connection service capability information of the terminal device, service type description information of the AI service, and service target description information of the AI service.

7. The method according to claim 1, wherein the receiving or sending the service information of the AI service based on the configuration information of the AI service comprises:
receiving or sending data resource information of the AI service based on the configuration information of the AI service.

8. The method according to claim 1, wherein before receiving the configuration information of the AI service, the method further comprises:
sending capability information, wherein the capability information comprises at least one of the local data service capability information of the terminal device, the local computing service capability information of the terminal device, the local sensing service capability information of the terminal device, and the local connection service capability information of the terminal device; and
receiving a response to the capability information.

9. The method according to claim 8, wherein
the capability information is carried in a service registration message, and the response to the capability information is carried in a service registration response message; or
the capability information is carried in a service deregistration message, and the response to the capability information is carried in a service deregistration response message; or
the capability information is carried in a service update message, and the response to the capability information is carried in a service update response message.

10. A communication method, applied to a first network device side and comprising:
sending configuration information of an artificial intelligence (AI) service, wherein the configuration information of the AI service indicates configuration information of a connection function and at least one of the following: an identifier of the AI service, configuration information of a computing function, configuration information of a sensing function, or configuration information of a data function; and
receiving or sending service information of the AI service based on the configuration information of the AI service.

11. The method according to claim 10, wherein
the configuration information of the connection function comprises at least one of configuration information of a service data adaptation (SDAP) layer, configuration information of a packet data convergence (PDCP) layer, configuration information of a radio link control (RLC) layer, configuration information of a media access control (MAC) layer, or configuration information of a physical (PHY) layer; or
the configuration information of the computing function is for AI model training and/or AI model inference; or
the configuration information of the sensing function is for environment parameter measurement and/or environment parameter reporting; or
the configuration information of the data function is used to collect data and/or augment data.

12. The method according to claim 10, wherein a part or all of the service information of the AI service is carried on a physical downlink shared channel (PDSCH), and control information associated with the PDSCH indicates the AI service.

13. The method according to claim 12, wherein the control information is downlink control information (DCI) or a media access control control element (MAC CE) transmitted on a physical downlink control channel (PDCCH).

14. The method according to claim 10, wherein before sending the configuration information of the AI service, the method further comprises:
receiving request information used to request the AI service.

15. The method according to claim 14, wherein the request information comprises at least one of the following:
local data resource information of a terminal device, motion status information of the terminal device, local data service capability information of the terminal device, local computing service capability information of the terminal device, local sensing service capability information of the terminal device, local connection service capability information of the terminal device, service type description information of the AI service, or service target description information of the AI service.

16. The method according to claim 15, wherein the receiving or sending the service information of the AI service based on the configuration information of the AI service comprises:
receiving or sending data resource information of the AI service based on the configuration information of the AI service.

17. The method according to claim 10, wherein before the sending the configuration information of the AI service, the method further comprises:
receiving capability information, wherein the capability information comprises at least one of the local data service capability information of the terminal device, the local computing service capability information of the terminal device, the local sensing service capability information of the terminal device, or the local connection service capability information of the terminal device; and
sending a response to the capability information.

18. The method according to claim 17, wherein
the capability information is carried in a service registration message, and the response to the capability information is carried in a service registration response message; or
the capability information is carried in a service deregistration message, and the response to the capability information is carried in a service deregistration response message; or
the capability information is carried in a service update message, and the response to the capability information is carried in a service update response message.

19. The method according to claim 17, wherein the method further comprises:
sending, to a second network device, indication information indicating the capability information.

20. A communication apparatus, wherein the apparatus comprises a transceiver unit and a processing unit, wherein
the transceiver unit is configured to receive configuration information of an artificial intelligence (AI) service, wherein the configuration information of the AI service indicates configuration information of a connection function and at least one of the following: an identifier of the AI service, configuration information of a computing function, configuration information of a sensing function, and configuration information of a data function; and
the processing unit is configured to receive or send, via the transceiver unit, service information of the AI service based on the configuration information of the AI service.
